(19) United States
(12) Patent Application Publication
(10) Pub. No.: US 2009/0325735 A1
(43) Pub. Date: Dec. 31, 2009

(54) POCKET-FRIENDLY GOLF ACCESSORY CARD

(76) Inventors: Michael Grant Mier, Henderson, NV (US); Ralph William Mier, Camarillo, CA (US); Gregory John Mier, Henderson, NV (US)

Correspondence Address: GOLD & RIZVI, P.A., 600 N. PINE ISLAND ROAD, SUITE 450, PLANTATION, FL, 33324-1311, US

(21) Appl. No.: 12/491,525

(22) Filed: Jun. 25, 2009

Related U.S. Application Data
(60) Provisional application No. 61/208,749, filed on Feb. 27, 2009.
(60) Provisional application No. 61/196,062, filed on Oct. 14, 2008.
(60) Provisional application No. 61/137,591, filed on Jul. 31, 2008.
(60) Provisional application No. 61/133,230, filed on Jun. 25, 2008.

(51) Int. Cl. A63B 57/00; B32B 37/02

(52) U.S. Cl. 473/388; 473/406; 473/407; 156/268

(57) ABSTRACT

A pocket-friendly golf accessory card formed of a prepared, uniquely constructed sheet of joint-able material is provided from which one or more golf accessories are manually formable.

The golf accessory formable from the card comprises one or more golf tees, golf ball position markers, directional vanes, and golf ball liners.

The flat pocket-friendly golf accessory card is configured with one or more CUTS formed by cutting through the card and with one or more JOINTS formed by cutting through a portion of the card. These one or more CUTS and JOINTS within the joint-able material facilitate the detachment or the bending of particular lines to form the various card configurations, which are then functionally usable as a golf accessory.

Not only does the pocket-friendly golf accessory card provide a beneficial, functioning golf accessory, it also is customizable for promotional or marketing purposes by standard printing techniques.

### CROSS-REFERENCE TO RELATED APPLICATION

This Non-Provisional application claims the benefit of co-pending U.S. Provisional Patent Application Ser. No. 61/208,749, filed on Feb. 27, 2009, co-pending U.S. Provisional Patent Application Ser. No. 61/196,062, filed on Oct. 14, 2008, co-pending U.S. Provisional Patent Application Ser. No. 61/137,591, filed on Jul. 31, 2008, and co-pending U.S. Provisional Patent Application Ser. No. 61/133,230, filed on Jun. 25, 2008, which are incorporated herein in their entirety.

### BACKGROUND OF THE INVENTION

1. Field of the Invention

The present invention relates generally to golf accessories, and more particularly, to a pocket-friendly golf accessory card incorporating manually formable golf accessories.

2. Description of the Prior Art

Golf is a popular sport for recreation and exercise. With the lowest possible number of strokes, a golfer uses a club to hit a golf ball into each hole of the golf course.

A golfer often purchases many accessories in pursuit of his or her favorite sport. Such accessories include golf tees, golf ball position markers, directional vanes, and golf ball liners.

For the first shot of each hole, a golf tee is used to support the golf ball off the ground. Most golf tees are made of solid plastic or wood in one body. Golf tees generally include a circular top disc head portion for receiving and supporting a golf ball, a neck portion, and a shaft section ending in a pointed end for penetrating the golf tee into the ground. However, at times conventional tees are unusable, for instance on artificial golf mats.

Golf ball position markers are used to hold the position of the golf ball when the ball needs to be cleaned or when it is in an opponent's putting line. They are often heavy, circular, flat discs, sometimes with fixed spikes. Golf ball position markers with spikes may cause injury if held in a pocket while walking or swinging. Heavy, bulky markers can cause an opponent's ball to sway off course, if the ball rolls over it.

Other golf accessories provide visual alignment assistance to line-up a putt while on the golf green. For example, golf ball liners are marking stencils that allow a golfer to mark a straight line on their ball to provide a visual alignment guide. Although a golfer first stands behind the ball and aligns it with the hole, when he moves into the address position to swing, his perception changes. An alignment line placed on the ball by a ball liner gives the golfer a visual advantage, assisting in alignment and in hitting the ball squarely, and orienting the direction of an accurate putt. Currently available visual alignment aids are made of bulky plastic and are oddly shaped, so are not easy to store or transport. They are relatively expensive, and they have no promotional value.

Another visual alignment golf accessory is a directional pointer for a golf tee, which slides onto the shaft of the tee. However, currently available directional pointers are not suitable for printing, promotions, or advertising with the ease and accessibility of a card format.

Many currently available golf accessories are relatively expensive and bulky. Many are relatively complex to manufacture. Also, due to their small size, they are commonly easy to lose in a golf bag. Further, as they are awkwardly shaped, they are difficult to store, to transport, and to have available for convenient use. Additionally, it often happens that golfers either forget, or run out of, golf tees, ball markers, or ball liners during a round of golf.

Additionally, many currently available golf accessories do not provide a medium upon which promotional advertising can be displayed.

Accordingly, there is an established need for a simple golf accessory that provides advantages to the golfer (being portable, easy to use, economical, easy to store, convenient to transport, and readily available for use), provides advantages to the manufacturer (being efficient, straightforward, and very inexpensive to fabricate), and provides advantages to the issuer or advertiser (providing a superior medium for printing or for incorporating a design into the golf accessory configuration itself).

### SUMMARY OF THE INVENTION

The present invention is directed to an inexpensive pocket-friendly golf accessory card from which one or more convenient and functional golf accessories can be manually folded and formed by the user.

The pocket-friendly golf accessory card comprises a prepared, uniquely constructed sheet platform of joint-able material of one or more layers (such as, for example, a credit card-sized laminated Teslin® or PVC plastic card) that may be imprinted with advertising, instruction, barcodes, magnetic stripes, or other desirable graphics, markings, or customizations.

The one or more golf accessories formable from the card comprise golf tees, golf ball position markers, directional vanes, and golf ball liners.

The flat pocket-friendly golf accessory card is configured with at least one separation formed by cutting through the card and with at least one joint formed by cutting through a portion, or a single layer, of the card. These one or more separations and joints within the joint-able material facilitate the detachment of particular cut lines or the bending of particular joint lines to form the various card configurations, which are then functionally usable as a golf accessory.

Not only does the pocket-friendly golf accessory card provide a beneficial, functioning golf accessory, the card is also quite inexpensive to produce and is customizable for promotional or marketing purposes by standard printing techniques.

An object of the present invention is to provide a pocket-friendly golf accessory card that can be printed with text, graphics, or other markings.

Another object of the present invention is to provide a pocket-friendly golf accessory card that can be used for any of a number of promotional and marketing purposes.

A further object of the present invention is to provide a pocket-friendly golf accessory card that can be used to display instructional information.

An additional object of the present invention is to provide a pocket-friendly golf accessory card that is very lightweight.

A further object of the present invention is to provide a pocket-friendly golf accessory card that is quite inexpensive to manufacture.

Another object of the present invention is to provide a pocket-friendly golf accessory card that is convenient to carry, such as in a wallet, pocket, purse, or golf bag.

A further object of the present invention is to provide a pocket-friendly golf accessory card that is easy to store.

An additional object of the present invention is to provide a golf tee from the pocket-friendly golf accessory card of the present invention.

Another object of the present invention is to provide a golf directional vane from the pocket-friendly golf accessory card of the present invention.

An additional object of the present invention is to provide a ball marker from the pocket-friendly golf accessory card of the present invention.

A further object of the present invention is to provide a ball liner from the pocket-friendly golf accessory card of the present invention.

These and other objects, features, and advantages of the present invention will become more readily apparent from the attached drawings and from the detailed description of the preferred embodiments, which follow.

### BRIEF DESCRIPTION OF THE DRAWINGS

The preferred embodiments of the invention will hereinafter be described in conjunction with the appended drawings, provided to illustrate and not to limit the invention, where like designations denote like elements, and in which:

FIG. 1 is a flat top view showing a first exemplary embodiment, Card A, of the pocket-friendly golf accessory card of the present invention;

FIG. 2 is a functional perspective view showing the first exemplary embodiment, Card A, of the pocket-friendly golf accessory card of the present invention;

FIG. 3 is a functional front view showing the first exemplary embodiment, Card A, of the pocket-friendly golf accessory card of the present invention with a golf ball installed;

FIG. 4 is a functional side view showing the first exemplary embodiment, Card A, of the pocket-friendly golf accessory card of the present invention with a golf ball installed;

FIG. 5 is a flat top view showing the second exemplary embodiment, Card B, of the pocket-friendly golf accessory card of the present invention;

FIG. 6 is a functional perspective view showing the second exemplary embodiment, Card B, of the pocket-friendly golf accessory card of the present invention;

FIG. 7 is a functional front view showing the second embodiment, Card B, of the pocket-friendly golf accessory card of the present invention with a golf ball installed;

FIG. 8 is a functional side view showing the second exemplary embodiment, Card B, of the pocket-friendly golf accessory card of the present invention with a golf ball installed;

FIG. 9 is a flat top view showing the third exemplary embodiment, Card C, of the pocket-friendly golf accessory card of the present invention;

FIG. 10 is a functional perspective view showing the third exemplary embodiment, Card C, of the pocket-friendly golf accessory card of the present invention;

FIG. 11 is a functional front view showing the third embodiment, Card C, of the pocket-friendly golf accessory card of the present invention with a golf ball installed;

FIG. 12 is a functional side view showing the third exemplary embodiment, Card C, of the pocket-friendly golf accessory card of the present invention with a golf ball installed;

FIG. 13 is a flat top view showing the fourth exemplary embodiment, Card D, of the pocket-friendly golf accessory card of the present invention;

FIG. 14 is a functional perspective view showing the fourth exemplary embodiment, Card D, of the pocket-friendly golf accessory card of the present invention;

FIG. 15 is a functional front view showing the fourth embodiment, Card D, of the pocket-friendly golf accessory card of the present invention with a golf ball installed;

FIG. 16 is a functional side view showing the fourth exemplary embodiment, Card D, of the pocket-friendly golf accessory card of the present invention with a golf ball installed;

FIG. 17 is a flat top view showing the fifth exemplary embodiment, Card E, of the pocket-friendly golf accessory card of the present invention;

FIG. 18 is a functional perspective view showing the fifth exemplary embodiment, Card E, of the pocket-friendly golf accessory card of the present invention;

FIG. 19 is a functional front view showing the fifth embodiment, Card E, of the pocket-friendly golf accessory card of the present invention with a golf ball installed;

FIG. 20 is a functional side view showing the fifth exemplary embodiment, Card E, of the pocket-friendly golf accessory card of the present invention with a golf ball installed;

FIG. 21 is a flat top view showing the sixth exemplary embodiment, Card F, of the pocket-friendly golf accessory card of the present invention;

FIG. 22 is a functional perspective view showing the sixth exemplary embodiment, Card F, of the pocket-friendly golf accessory card of the present invention;

FIG. 23 is a functional front view showing the sixth embodiment, Card F, of the pocket-friendly golf accessory card of the present invention with a golf ball installed;

FIG. 24 is a functional side view showing the sixth exemplary embodiment, Card F, of the pocket-friendly golf accessory card of the present invention with a golf ball installed;

FIG. 25 is a flat top view showing the seventh exemplary embodiment, Card G, of the pocket-friendly golf accessory card of the present invention;

FIG. 26 is a functional perspective view showing the seventh exemplary embodiment, Card G, of the pocket-friendly golf accessory card of the present invention illustrating a narrow-front, vertical fold;

FIG. 27 is a functional perspective view showing the seventh exemplary embodiment, Card G, of the pocket-friendly golf accessory card of the present invention illustrating a wide-front, horizontal fold;

FIG. 28 is a functional front view showing the seventh embodiment, Card G, of the pocket-friendly golf accessory card of the present invention folded with a narrow-front, vertical fold and with a golf ball installed;

FIG. 29 is a functional side view showing the seventh exemplary embodiment, Card G, of the pocket-friendly golf accessory card of the present invention folded with a narrow-front, vertical fold and with a golf ball installed;

FIG. 30 is a functional front view showing the seventh embodiment, Card G, of the pocket-friendly golf accessory card of the present invention folded with a wide-front, horizontal fold and with a golf ball installed;

FIG. 31 is a functional side view showing the seventh exemplary embodiment, Card G, of the pocket-friendly golf accessory card of the present invention folded with a wide-front, horizontal fold and with a golf ball installed;

FIG. 32 is a flat top view showing the eighth exemplary embodiment, Card H, of the pocket-friendly golf accessory card of the present invention;

FIG. 33 is a functional perspective view showing the eighth exemplary embodiment, Card H, of the pocket-friendly golf accessory card of the present invention illustrating a narrow-front, vertical fold;

FIG. 34 is a functional front view showing the eighth embodiment, Card H, of the pocket-friendly golf accessory card of the present invention folded with a narrow-front, vertical fold and with a golf ball installed;

FIG. 35 is a functional front view showing the eighth exemplary embodiment, Card H, of the pocket-friendly golf accessory card of the present invention folded with a wide-front, horizontal fold and with a golf ball installed;

FIG. 36 is a functional side view showing the eighth embodiment, Card H, of the pocket-friendly golf accessory card of the present invention folded with a narrow-front fold and with a golf ball installed;

FIG. 37 is a functional side view showing the eighth exemplary embodiment, Card H, of the pocket-friendly golf accessory card of the present invention folded with a wide-front fold and with a golf ball installed;

FIG. 38 is a flat top view showing the ninth exemplary embodiment, Card J, of the pocket-friendly golf accessory card of the present invention;

FIG. 39 is a functional perspective view showing a single golf ball marker detached from the Card J of the ninth exemplary embodiment of the pocket-friendly golf accessory card of the present invention;

FIG. 40 is a flat top view showing the tenth exemplary embodiment, a first multi-accessory Card K, of the pocket-friendly golf accessory card of the present invention illustrating multiple golf accessories within a single card;

FIG. 41 is a functional perspective view showing a first tee detached from first multi-accessory Card K of the tenth exemplary embodiment of the pocket-friendly golf accessory card of the present invention;

FIG. 42 is a functional perspective view showing a second tee detached from first multi-accessory Card K of the tenth exemplary embodiment of the pocket-friendly golf accessory card of the present invention;

FIG. 43 is a functional perspective view showing a first ball marker detached from first multi-accessory Card K of the tenth exemplary embodiment of the pocket-friendly golf accessory card of the present invention;

FIG. 44 is a functional perspective view showing a second ball marker detached from first multi-accessory Card K of the tenth exemplary embodiment of the pocket-friendly golf accessory card of the present invention;

FIG. 45 is a flat top view showing a first ball liner from Card L of the eleventh exemplary embodiment of the pocket-friendly golf accessory card of the present invention;

FIG. 46 is a functional perspective view showing the first ball liner from Card L of the eleventh exemplary embodiment of the pocket-friendly golf accessory card of the present invention;

FIG. 47 is a front view showing the marking line produced on the golf ball by the ball liner from Card L of the eleventh exemplary embodiment of the pocket-friendly golf accessory card of the present invention;

FIG. 48 is a flat top view illustrating a second multi-accessory card, Card M of the twelfth exemplary embodiment of the pocket-friendly golf accessory card of the present invention;

FIG. 49 is a flat top view illustrating a third multi-accessory card, Card N of the thirteenth exemplary embodiment of the pocket-friendly golf accessory card of the present invention;

FIG. 50 is a flat top view illustrating a fourth multi-accessory card, Card P of the fourteenth exemplary embodiment of the pocket-friendly golf accessory card of the present invention;

FIG. 51 is a flat top view illustrating a second ball liner card, Card Q of the fifteenth exemplary embodiment of the pocket-friendly golf accessory card of the present invention;

FIG. 52 is a functional perspective view illustrating the second ball liner card, Card Q, of the fifteenth exemplary embodiment of the pocket-friendly golf accessory card of the present invention in the operative position for receiving and marking the golf ball;

FIG. 53 is a front view showing the marking line (or lines) produced on the golf ball by the second ball liner card, Card Q, of the fifteenth exemplary embodiment of the pocket-friendly golf accessory card of the present invention;

FIG. 54 is a flat top view illustrating a first directional vane card, Card R, of the sixteenth exemplary embodiment of the pocket-friendly golf accessory card of the present invention;

FIG. 55 is a functional top view illustrating a first single directional vane 316 detached from the first directional vane card, Card R, of the sixteenth exemplary embodiment of the pocket-friendly golf accessory card of the present invention, as it is applied to a tee with a golf ball placed thereon;

FIG. 56 is a functional top view illustrating a second single directional vane 314 detached from the first directional vane card, Card R, of the sixteenth exemplary embodiment of the pocket-friendly golf accessory card of the present invention, as it is applied to a tee with a golf ball placed thereon;

FIG. 57 is a functional perspective view illustrating the first single directional vane 316 detached from the first directional vane card, Card R, of the sixteenth exemplary embodiment of the pocket-friendly golf accessory card of the present invention, as it is applied to a tee with a golf ball placed thereon;

FIG. 58 is a functional perspective view illustrating a second single directional vane 314 detached from the first directional vane card, Card R, of the sixteenth exemplary embodiment of the pocket-friendly golf accessory card of the present invention, as it is applied to a tee with a golf ball placed thereon;

FIG. 59 is a flat top view illustrating a second directional vane card, Card S, showing the seventeenth and eighteenth exemplary embodiments of directional vanes of the pocket-friendly golf accessory card of the present invention;

FIG. 60 is a functional top view illustrating a single directional vane 324 or 326 detached from the second directional vane card, Card S, of the seventeenth and eighteenth exemplary embodiments of directional vanes of the pocket-friendly golf accessory card of the present invention, as it is applied to a tee with a golf ball placed thereon;

FIG. 61 is a functional perspective view illustrating a single directional vane 324 detached from the second directional vane card, Card S, of the seventeenth exemplary embodiment of a directional vane of the pocket-friendly golf accessory card of the present invention, as it is applied to a tee with a golf ball placed thereon;

FIG. 62 is a flat top view illustrating a third directional vane card, Card T, of the nineteenth exemplary embodiment of the pocket-friendly golf accessory card of the present invention;

FIG. 63 is a functional top view illustrating the third directional vane card, Card T, of the nineteenth exemplary embodiment of the pocket-friendly golf accessory card of the present invention, as it is applied to a tee with a golf ball placed thereon;

FIG. 64 is a functional perspective view illustrating the third directional vane card, Card T, of the nineteenth exemplary embodiment of the pocket-friendly golf accessory card of the present invention, as it is applied to a tee with a golf ball placed thereon;

FIG. 65 is a flat top view illustrating a fourth directional vane card, Card U, of the twentieth exemplary embodiment of the pocket-friendly golf accessory card of the present invention;

FIG. 66 is a side flat view showing the layers produced by the preferred manufacturing technique of the exemplary embodiments of the pocket-friendly golf accessory card of the present invention;

FIG. 67 is an expanded view showing the layers produced by the preferred manufacturing technique of the exemplary embodiments of the pocket-friendly golf accessory card of the present invention; and

FIG. 68 is a diagram of exemplary template layouts and other applications for the pocket-friendly golf accessory card.

Like reference numerals refer to like parts throughout the numerous views of the drawings.

### DETAILED DESCRIPTION OF THE PREFERRED EMBODIMENTS

Shown throughout the figures, the present invention is directed toward a convenient pocket-friendly golf accessory card from which one or multiple golf accessories are manually formable by the golfer. The one or more golf accessories formable from the card comprise a golf tee, golf ball position marker, directional vane, and/or golf ball liner. One or more golf accessories can be arranged in any one of several layouts on the golf accessory card, and are either built into the golf accessory card itself or can be manually detached by the user from the golf accessory card.

Not only does the golf accessory card of the present invention provide a handy, functional accessory for the golfer, it also is customizable by standard printing techniques. Therefore, the card can also be used for promotional or marketing purposes such as business cards, golf bag tags, clothing tags, direct mail pieces, rack displays, and the like, with one or both sides of the card capable of supporting graphics, artwork, text, or other markings. Further, the pocket-friendly golf accessory card is easy and inexpensive to manufacture. Thus the pocket-friendly golf accessory card provides advantages to the golfer end user, to the manufacturer, and to the advertiser or issuer.

The pocket-friendly golf accessory card is formed of a sheet (which may be of one or more layers) of “joint-able” material, which is preferably a relatively thin, semi-rigid but flexible or joint-able material, such as, for example, laminated Teslin®, PVC plastic, PETG plastic, ABS plastic, high density polyethylene, polycarbonate, laminated paper, laminated Tyvex®, laminated Artisyn®, thick cardstock, plasticized fabric or fiber, silicone, thin aluminum, or another other suitable card or tag material having similar properties. In one aspect of the invention, the card can be made of a water proof, or water resistant, plastic to which graphics or artwork can be applied, and then laminated with a clear laminate film. Most preferably a laminated Teslin® may be used. The pocket-friendly golf accessory card is preferably sized similarly to a credit card, for convenience in carrying in a wallet with other plastic cards; however, other sizes are within the scope of the invention.

To enable the formation of the golf accessory from the pocket-friendly golf accessory card, the card is configured with one or more separations or “CUTS” formed by cutting through the card, or substantially through the card, and is configured with one or more “JOINTS” formed by cutting through a portion of the card. The one or more CUTS and one or more JOINTS within the joint-able material facilitate the detachment and/or the bending of particular failure/score lines to form the various card configurations, which are then functionally usable as a golf accessory. JOINTS allow the joint-able material to bend, pivot, or hinge without separating, yet allow the joint-able material to remain fixed in the desired position until manually returned to the original position by the user.

Further, the card may be configured with “TIES”, which are minute connections that allow the golf accessories to remain in a flat and fixed position relative to the plane of the card itself, until manually separated or detached by the user. To form the golf accessory certain parts of the card or accessory (labeled as “TABS”) may partially separate and generally function outside the plane(s) of the underlying card itself.

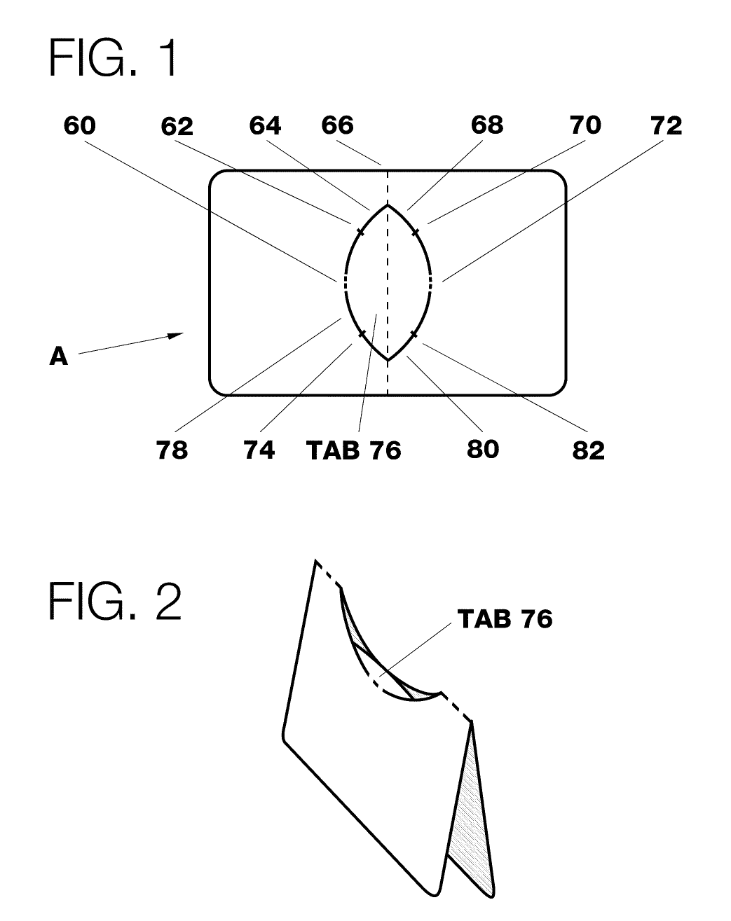

The drawings represent numerous embodiments of the different golf accessories of the present invention. For clarity of illustration and discussion the following designations are used to indicate particular portions or process results: (1) “CUTS” (for example: 64, 68, 78, and 80 in FIG. 1) are shown as solid lines within the interior of the card (inside the perimeter); (2) “JOINTS” (for example: 60, 66, and 72 in FIG. 1) are shown as dashed lines; (3) shaded areas of the drawings represent the reverse side or underside of the card or accessory; (4) “TIES” are shown as singular marks (for example: 62, 70, 74, and 82 in FIG. 1) amid the solid lines; and (5) “TABS” are labeled with the word “TAB” (for example 76 in FIG. 1).

The golf accessory is formed by detachment of particular areas at CUTS and by bending of other particular areas at JOINTS of the uniquely constructed sheet of joint-able material. Just as the three-dimensional golf accessory is manually formable from the flat card, it is also manually deformable from the three-dimensional golf accessory back into a substantially flat card. For example, the pocket-friendly golf accessory card may be taken from the wallet, the golf accessory formed, the golf accessory used, and then the golf accessory flattened back into the card for storage in the wallet. The entire card, or the individual accessories themselves can fit conveniently in a pocket without protruding parts.

The JOINTS may be formed in the joint-able material by any of a variety of techniques or methods, referred to herein as “scoring”. Scoring comprises perforation, pre-bending, kiss-cutting, forming depressions, micro-perforation, punching, die-cutting, laser cutting, stripping, varying thicknesses, abrading or other methods of creating stress or failure points. For example, if laminated Teslin® is used, the upper lamination 386 (FIG. 67) is cut wholly, or at least partially, allowing the Teslin® 387, and lower lamination 388 to flex at such established JOINT.

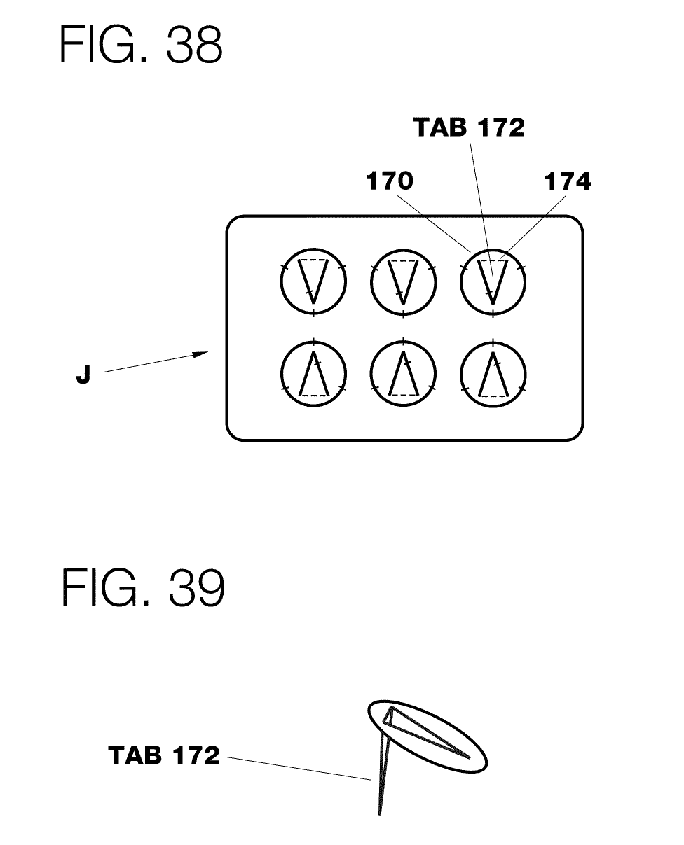

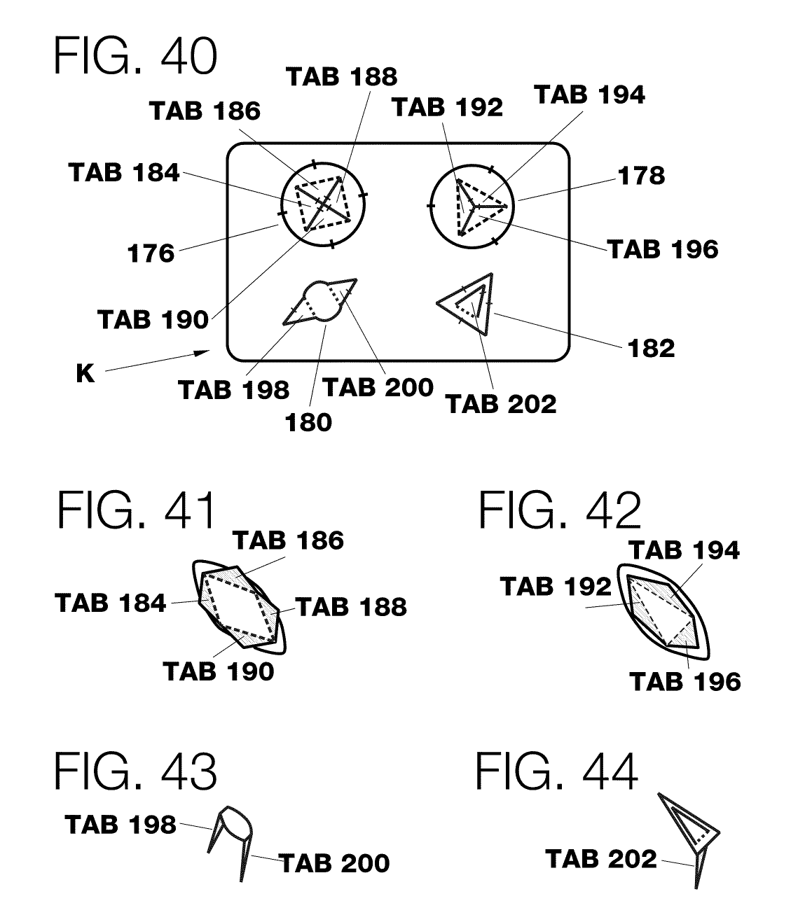

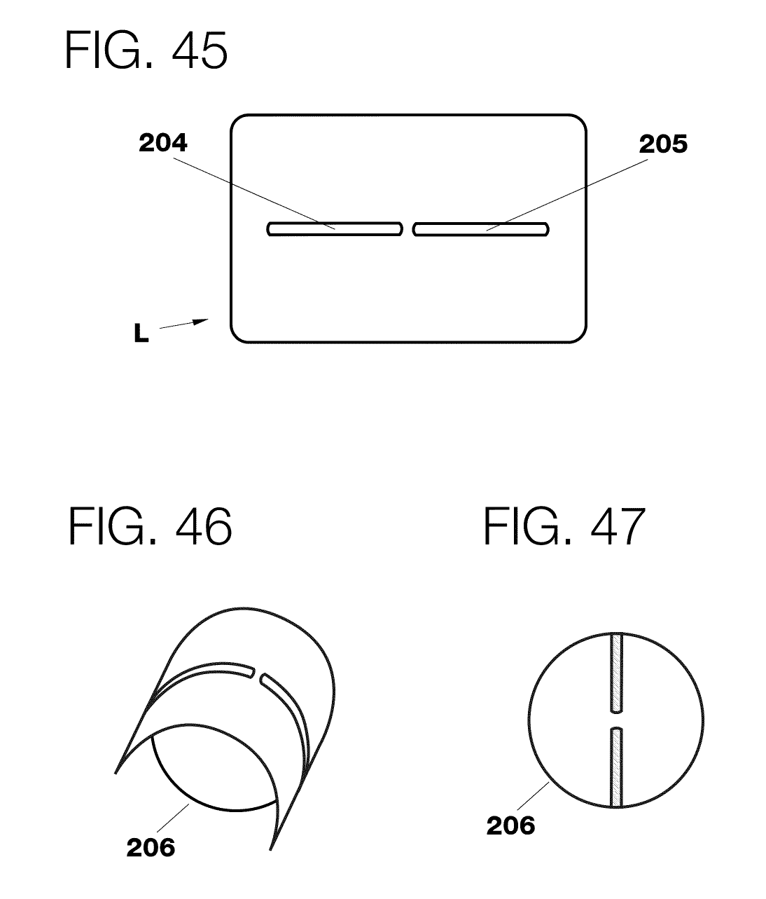

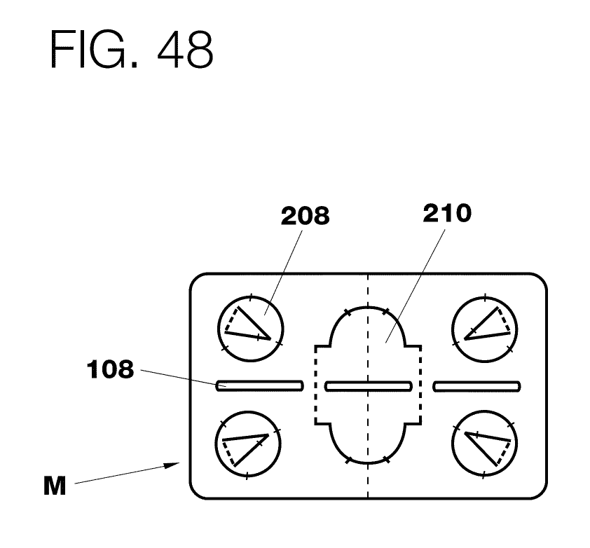

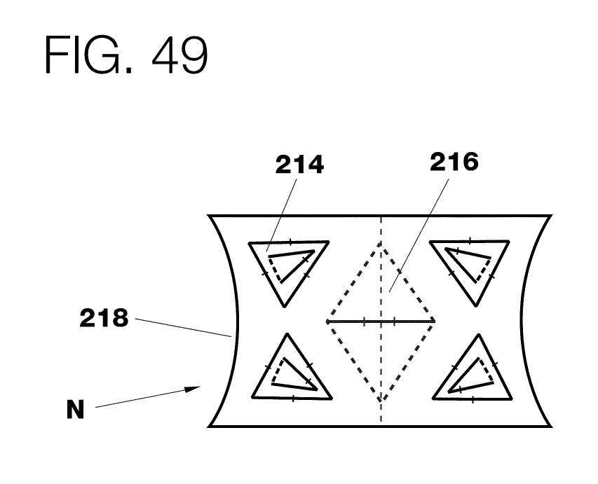

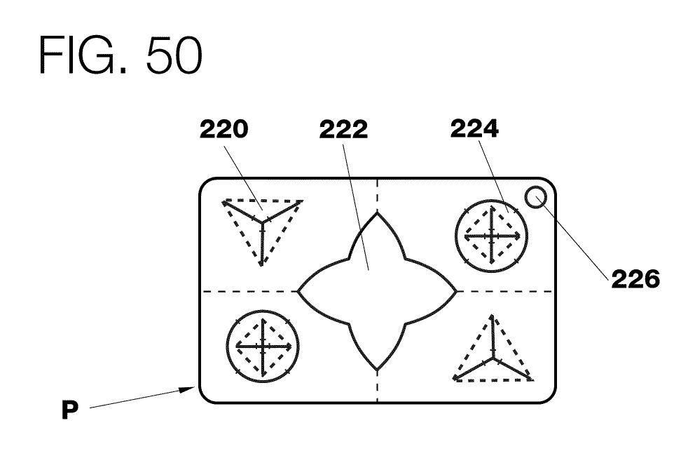

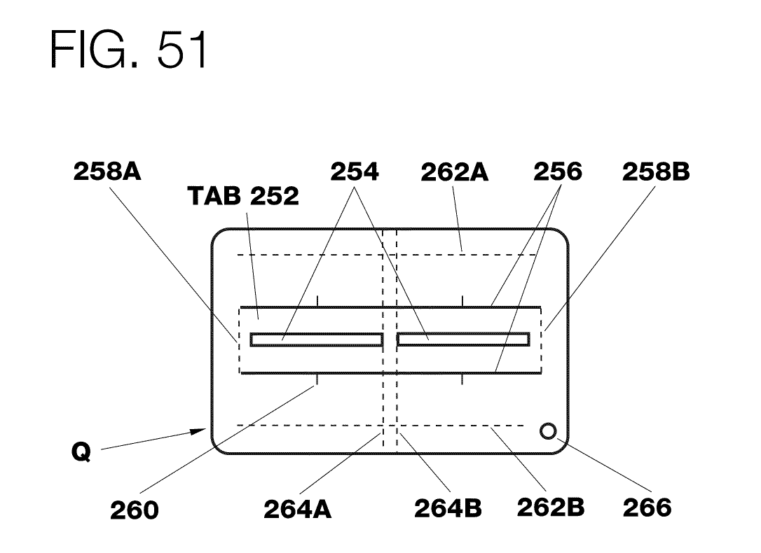

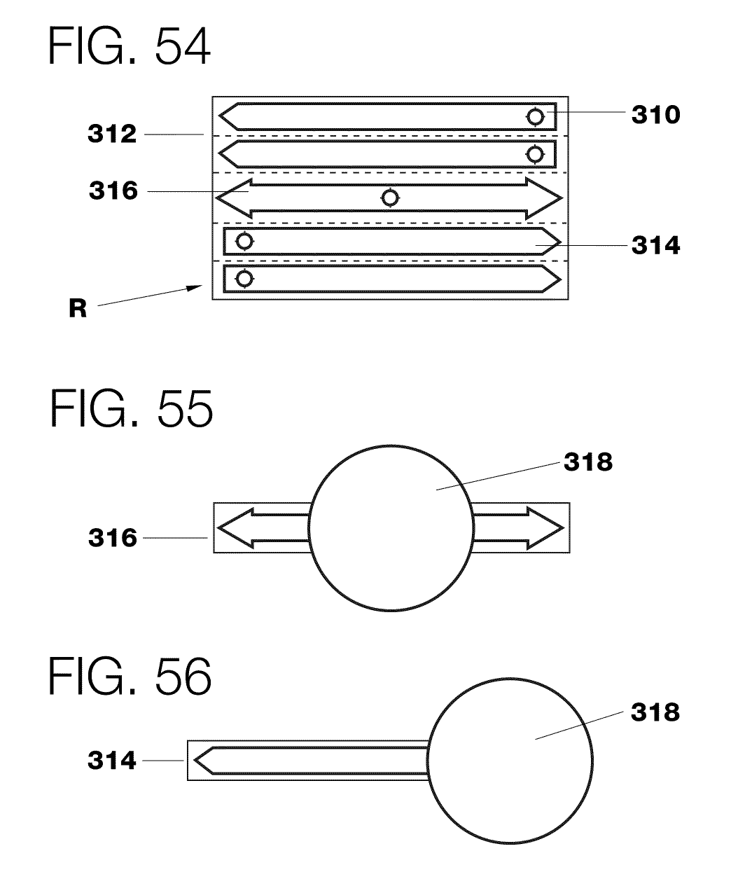

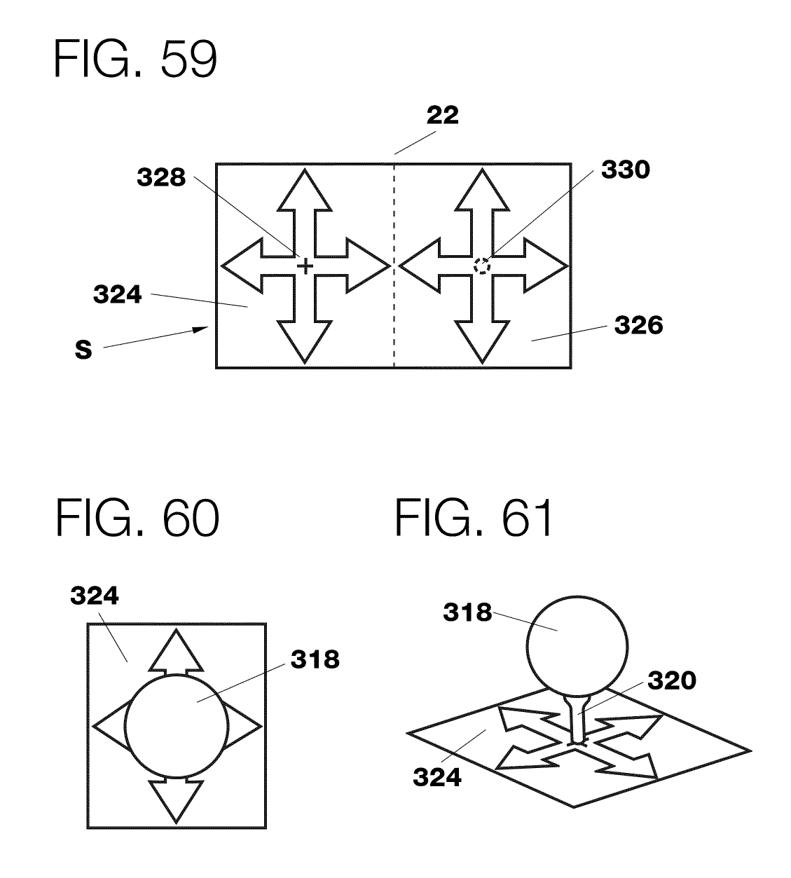

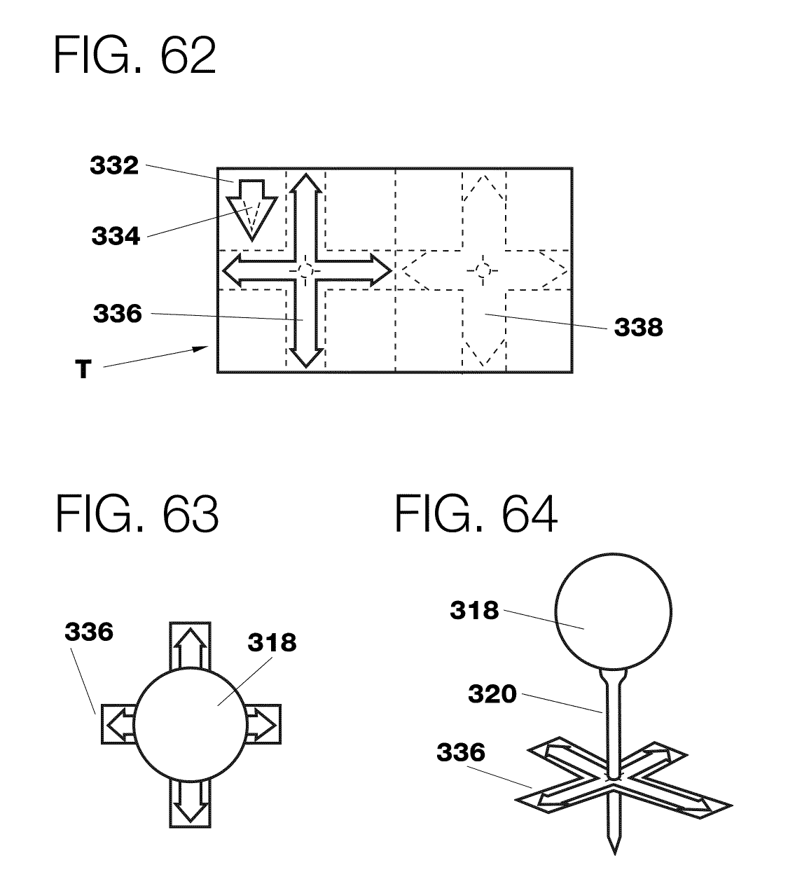

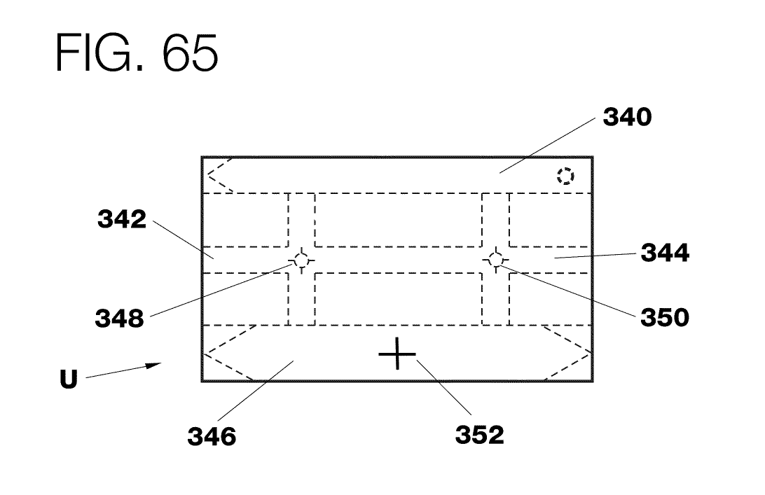

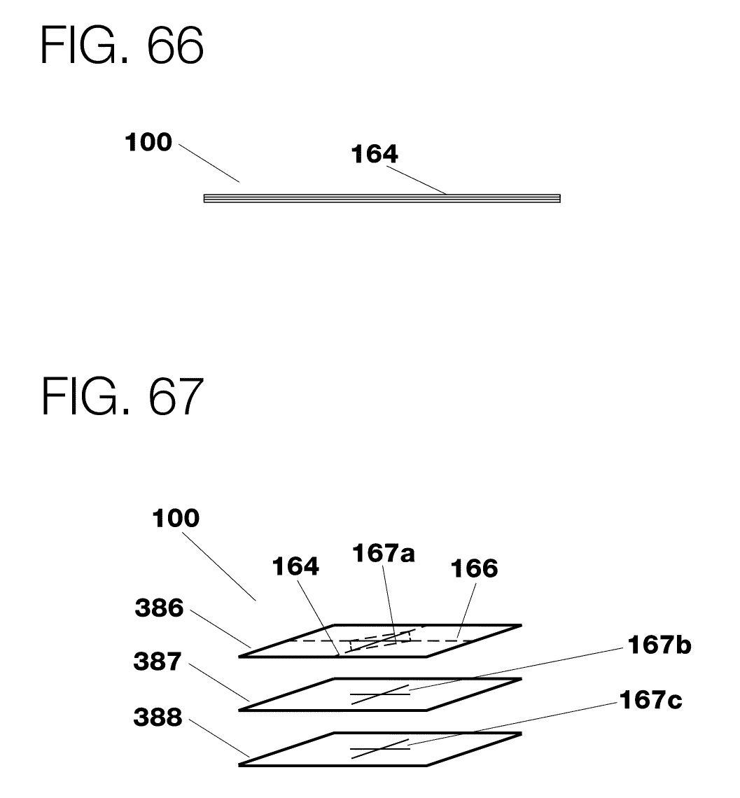

Turning now to the numerous embodiments of the pocket-friendly golf accessory card, the first eight embodiments comprise formable golf tees, Cards A to H (FIG. 1-FIG. 37); the ninth embodiment comprises formable ball markers, Card J (FIG. 38-FIG. 39); the tenth embodiment comprises a multi-accessory card, Card K (FIG. 40-FIG. 44); the eleventh embodiment comprises a first ball liner accessory card, Card L (FIG. 45-FIG. 47); the twelfth embodiment comprises a second multi-accessory card, Card M (FIG. 48); the thirteenth embodiment comprises a third multi-accessory card, Card N (FIG. 49); the fourteenth embodiment comprises a fourth multi-accessory card, Card P (FIG. 50); the fifteenth embodiment comprises a second ball liner card, Card Q (FIG. 51-FIG. 53), the sixteenth embodiment comprises a first directional vane card, Card R (FIG. 54-FIG. 58), the seventeenth and eighteenth embodiments comprise additional directional vanes, Card S (FIG. 59-FIG. 61), the nineteenth embodiment comprises an additional directional vane, Card T (FIG. 62-FIG. 64); the twentieth embodiment comprises an additional directional vane, Card U (FIG. 65); and FIG. 66-FIG. 67 illustrate the layers comprised by the accessory card.

Numerous exemplary variations are presented of the specific card configurations that form the golf tees of the first eight embodiments of Cards A to H (FIG. 1-FIG. 37). The numerous variations are shown to demonstrate the abundance of similar card configurations that are within the scope of the invention. Golf tees, formed from the pocket-friendly golf accessory card, that have two, three, four, and more points of contact with the ball are presented. Golf tees with a great deal of variation in the number and location of JOINTS and of CUTS are presented. This demonstration of variance shows that virtually any logo, layout, or graphic can be incorporated into the design of a functional golf tee formed from a pocket-friendly golf accessory card of the current invention.

Advantageously, the formable, functional golf tees herein presented are adjustable to allow a higher or lower elevation of the golf ball; also, they have fewer points of contact with the golf ball, as compared to the conventional tee in which the ball sits in a top disc or cup. Reducing the contact with the ball allows the ball to move more freely. Adjusting the height of the tee allows the golfer to adapt the tee as needed to the particular situation presented by the golf course. Another benefit of the formable tees herein presented is the ability to be utilized even on artificial golf mats or artificial turf.

The first embodiment, Card A, (FIG. 1-FIG. 4) illustrates a “solid face” tee in which no part of the tee is completely severable from the card itself. TAB 76 consists of CUTS 64, 68, 78, 80, TIES 62, 70, 74, 82, JOINTS 60, 72, and the middle portion of JOINT 66.

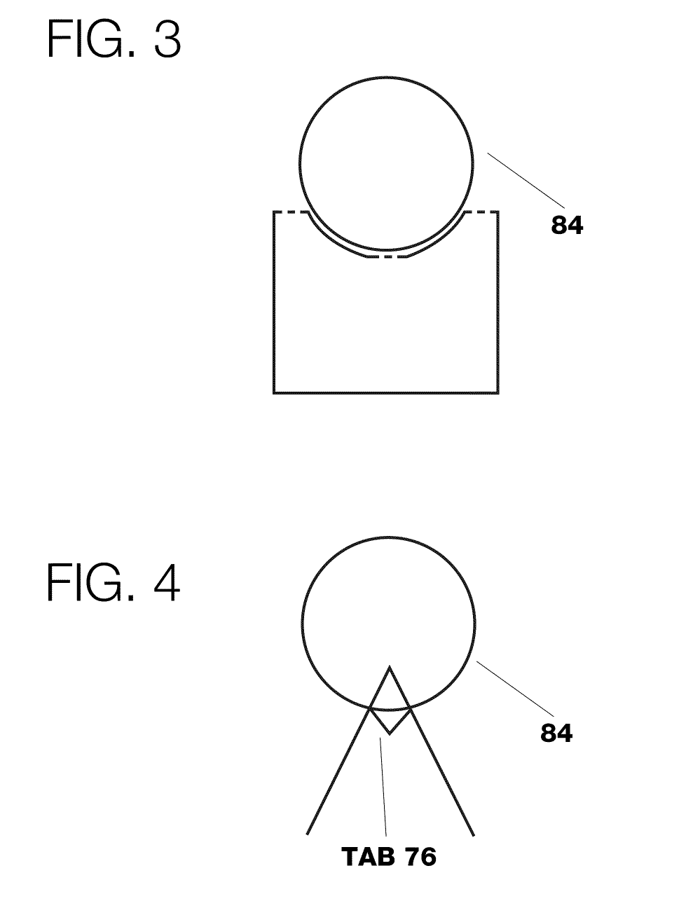

FIG. 2 is a functional, perspective view of Card A as it is used to function as a tee. The user simply folds TAB 76 in one direction while the remainder of the card itself is folded in the opposite direction. As shown in FIG. 3 (functional, front view) and FIG. 4 (functional, side view), the golf ball 84 is then placed upon the perimeter of TAB 76. The elevation of the golf ball 84 can then be adjusted by widening or narrowing the angle of the folded card. After use of Card A as a golf tee, the card can then be returned to a flat position as shown in FIG. 1.

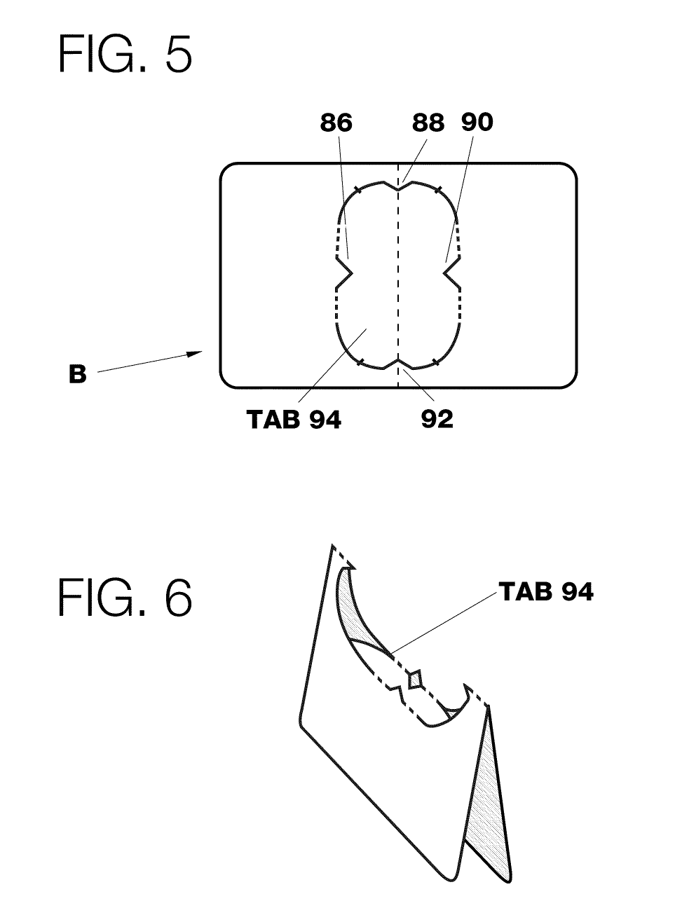

The second embodiment, Card B, (FIG. 5-FIG. 8) illustrates a “solid face” tee incorporating a two-point system. TAB 94 functions similarly to TAB 76 in FIG. 1 except that the golf ball rests upon points 86 and 90, and is centered thereon by points 88 and 92.

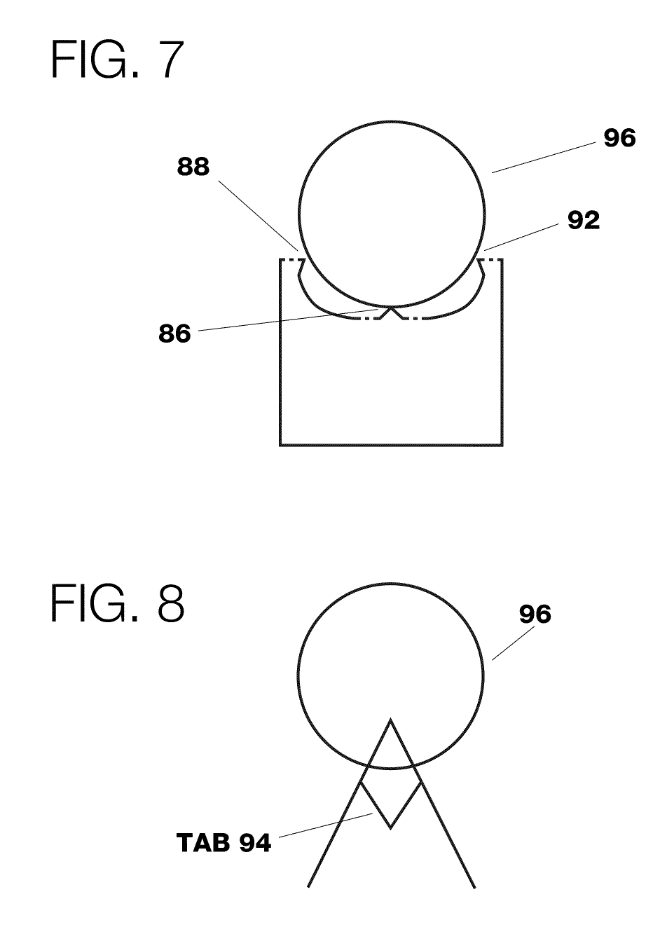

FIG. 6 is a functional, perspective view of Card B as it is used to function as a tee. The user simply folds TAB 94 in one direction while the remainder of the card itself is folded in the opposite direction. As shown in FIG. 7 (functional, front view) and FIG. 8 (functional, side view), the golf ball 96 is placed upon points 86 and 90. The elevation of the golf ball 96 can then be adjusted by widening or narrowing the angle of the folded card. After use of Card B as a golf tee, the card can then be returned to a flat position as shown in FIG. 5

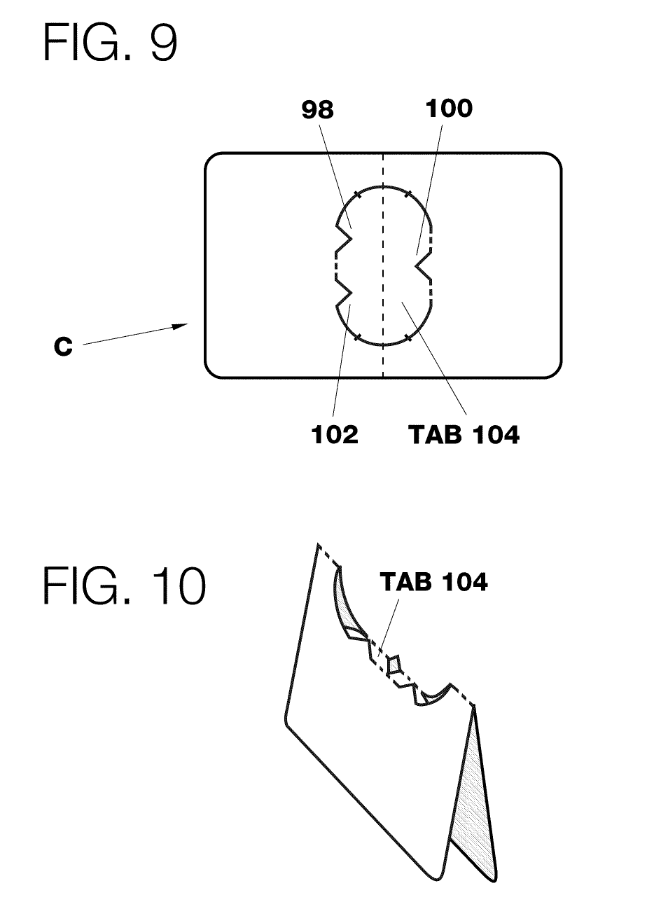

The third embodiment, Card C, (FIG. 9-FIG. 12) illustrates a “solid face” tee incorporating a three point system. TAB 104 functions similarly to TAB 76 in FIG. 1 except that the golf ball rests upon points 98, 100, and 102.

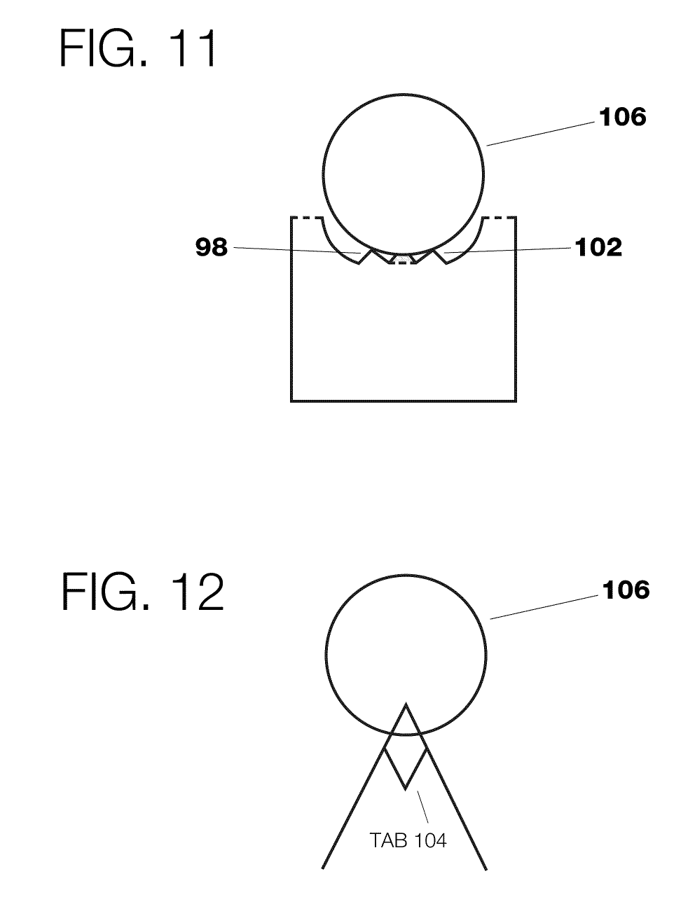

FIG. 10 is a functional, perspective view of Card C as it is used to function as a tee. The user simply folds TAB 104 in one direction while the remainder of the card itself is folded in the opposite direction. As shown in FIG. 11 (functional, front view) and FIG. 12 (functional, side view), the golf ball 106 is placed upon points 98, 100, and 102. The elevation of the golf ball 106 can then be adjusted by widening or narrowing the angle of the folded card. After use of Card C as a golf tee, the card can then be returned to a flat position as shown in FIG. 9.

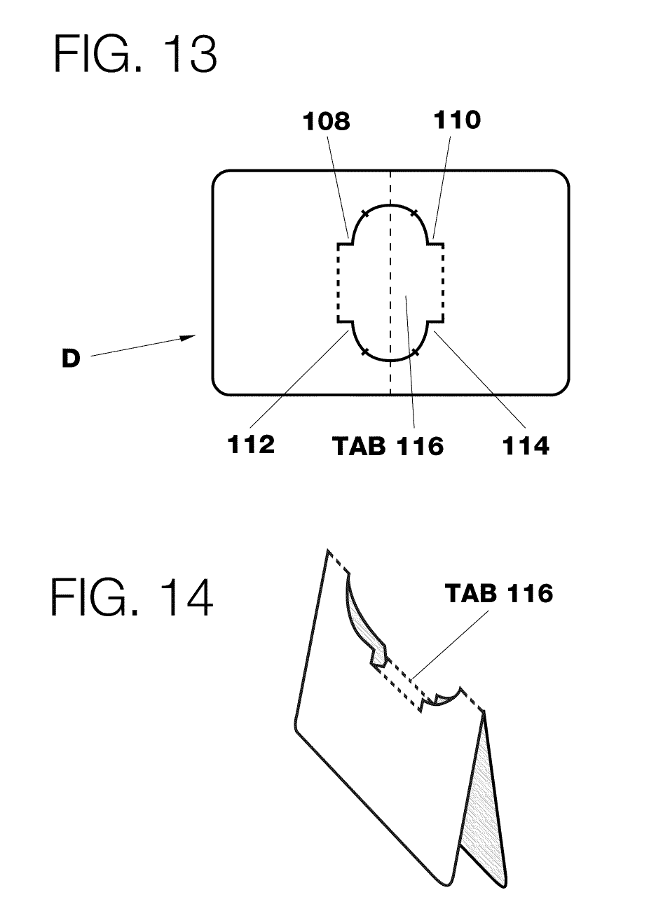

The fourth embodiment, Card D, (FIG. 13-FIG. 16) illustrates a “solid face” tee incorporating a four point system. TAB 116 functions similarly to TAB 76 in FIG. 1 except that the golf ball rests upon points 108, 110, 112, and 114.

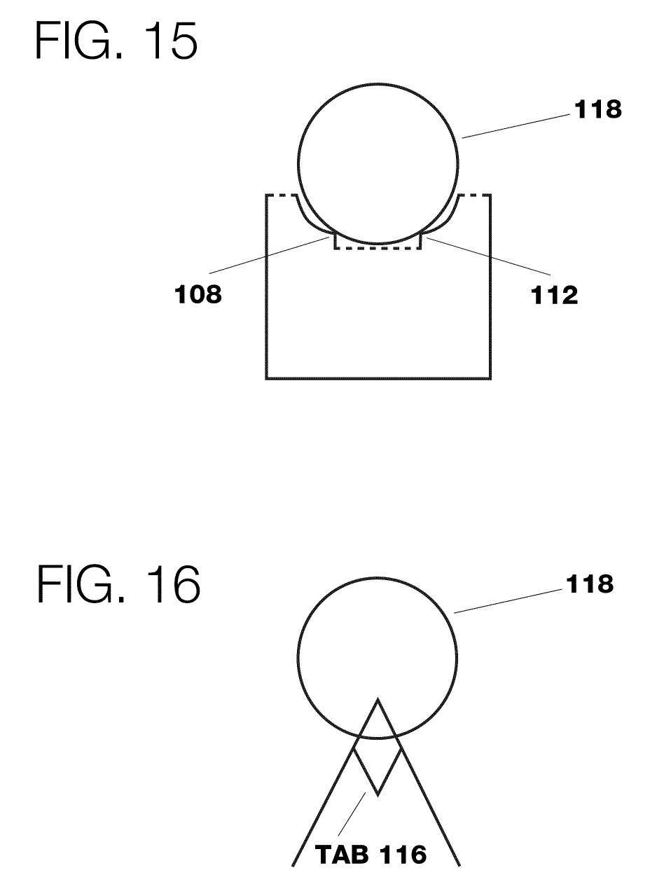

FIG. 14 is a functional, perspective view of Card D as it is used to function as a tee. The user simply folds TAB 116 in one direction while the remainder of the card itself is folded in the opposite direction. As shown in FIG. 15 (functional, front view) and FIG. 16 (functional, side view), the golf ball 118 is placed upon points 108, 110, 112, and 114. The elevation of the golf ball 118 can then be adjusted by widening or narrowing the angle of the folded card. After use of Card D as a golf tee, the card can then be returned to a flat position as shown in FIG. 13.

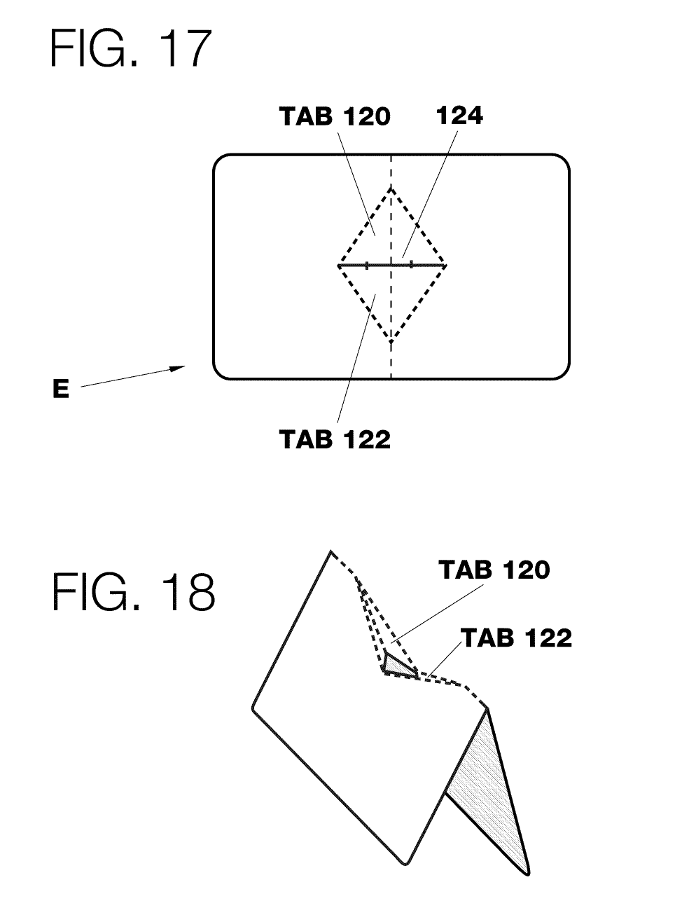

The fifth embodiment, Card E, (FIG. 17-FIG. 20) illustrates a “solid face” tee incorporating a two tab system. TAB 120 and TAB 122 are separated by CUT 124.

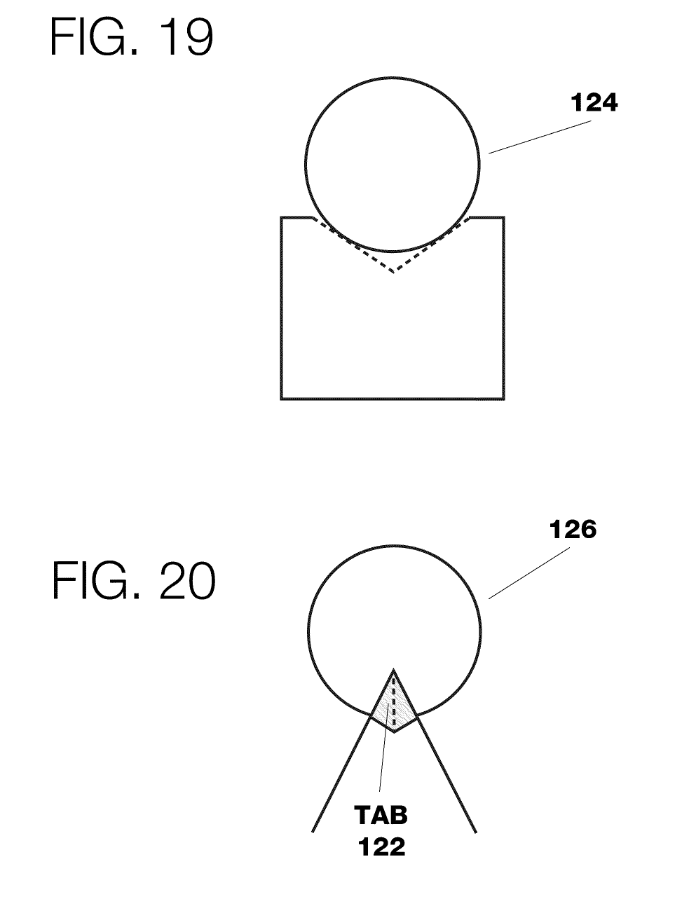

FIG. 18 is a functional, perspective view of Card E as it is used to function as a tee. The user simply folds both TAB 120 and TAB 122 in one direction while the remainder of the card itself is folded in the opposite direction. As shown in FIG. 19 (functional, front view) and FIG. 20 (functional, side view), the golf ball 126 is placed upon the perimeter of both TAB 120 and TAB 122. The elevation of the golf ball 126 can then be adjusted by widening or narrowing the angle of the folded card. After use of Card E as a golf tee, the card can then be returned to a flat position as shown in FIG. 17.

The sixth embodiment, Card F, (FIG. 21-FIG. 24) illustrates a “solid face” tee incorporating a three tab system. TAB 128, TAB 130, and TAB 132 are completely separated from each other and function independently.

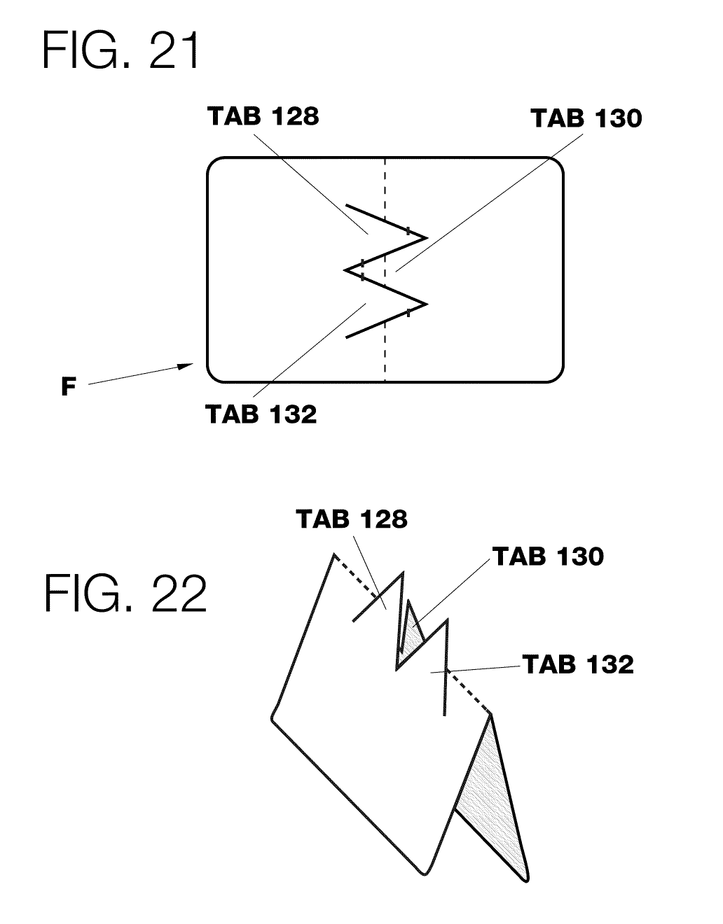

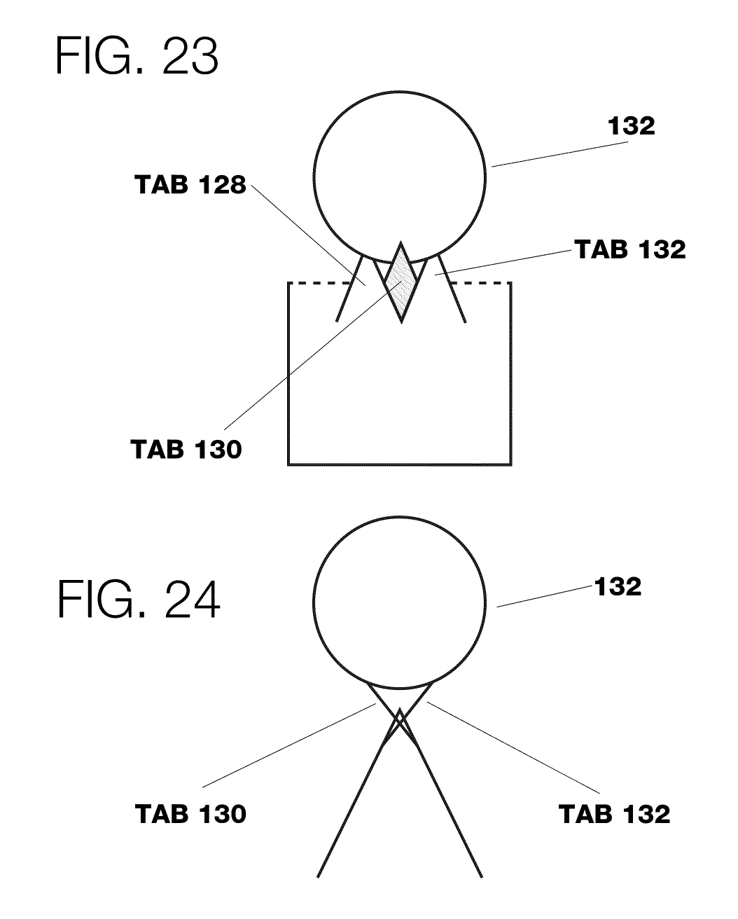

FIG. 22 is a functional, perspective view of Card F as it is used to function as a tee. The user simply folds the Card F in half, at the JOINT, causing TAB 128, TAB 130, and TAB 132 to separate and cross creating three points of contact upon which a golf ball can be placed. As shown in FIG. 23 (functional, front view) and FIG. 24 (functional, side view) the golf ball 132 is placed upon the crossing TABS 128, 130, and 132. The elevation of the golf ball 132 can then be adjusted by widening or narrowing the angle of the folded card. After use of Card F as a golf tee, the card can then be returned to a flat position as shown in FIG. 21.

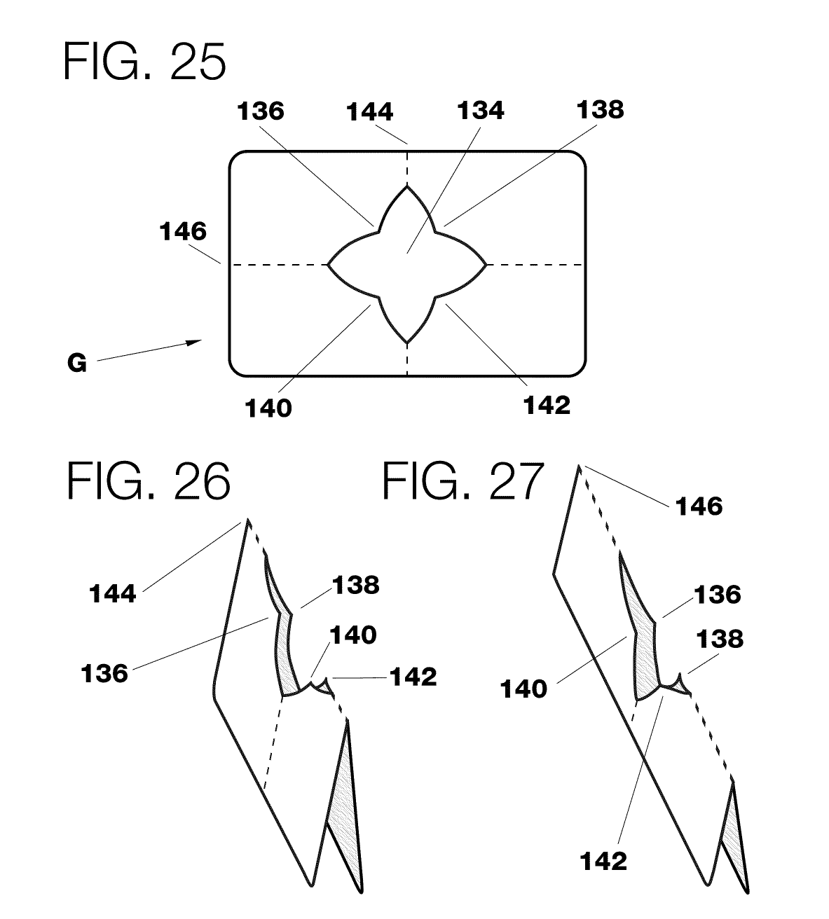

The seventh embodiment, Card G, (FIG. 25-FIG. 31) illustrates a formable tee allowing a higher initial tee elevation to accommodate the continuing trend of larger golf club heads. Under a similar embodiment, a four, or more, tab system can be used with similar effect.

FIG. 25 is a top view of Card G. Card G is a “pop-out” tee in which section 134 is not a tab but either an open section or a “pop-out” section to be removed by the user. Further, Card G is a “bi-fold” card which can be folded vertically along JOINT 144 to create a narrow front, or horizontally along JOINT 146, creating a wider front, in order to accommodate different tee elevations. The golf ball can rest, with either the vertical or the horizontal fold, upon points 136, 138, 140, and 142.

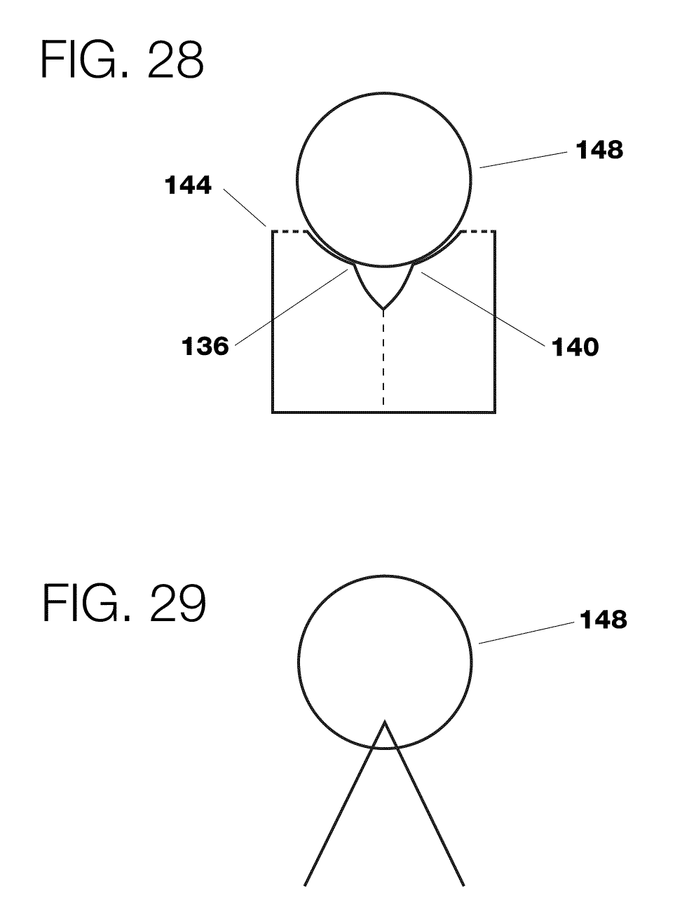

FIG. 26 is a functional, perspective view of the vertical fold along JOINT 144 as it is used to function as a tee. As shown in FIG. 28 (functional, front view) and FIG. 29 (functional, side view), the golf ball 148 is placed upon points 136, 138, 140, and 142. The elevation of the golf ball 148 can then be adjusted by widening or narrowing the angle of the folded card. After use of Card G as a golf tee, the card can then be returned to a flat position as shown in FIG. 25.

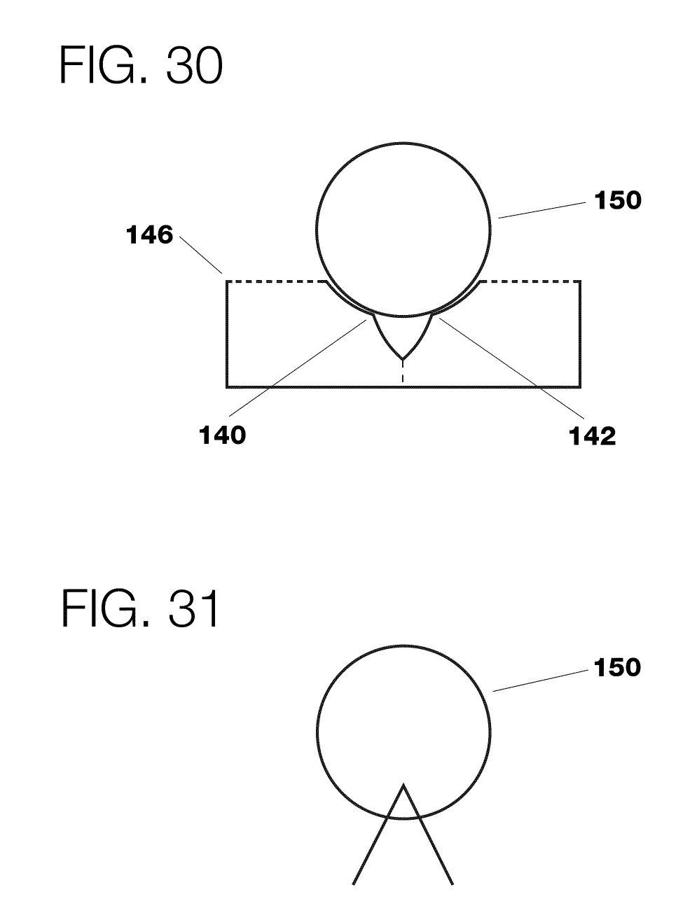

FIG. 27 is a functional, perspective view of the horizontal fold along JOINT 146 as it is used to function as a tee. As shown in FIG. 30 (functional, front view) and FIG. 31 (functional, side view), the golf ball 150 is placed upon points 136, 138, 140, and 142. The elevation of the golf ball 150 can then be adjusted by widening or narrowing the angle of the folded card. After use of Card G as a golf tee, the card can then be returned to a flat position as shown in FIG. 25.

Under this embodiment, and others, several shapes can be incorporated without diminishing the overall function of the tee system. For instance, a four leaf clover, an “iron cross”, a crucifix, and other popular or recognizable symbols and trademarks can be incorporated into the design of the tee or other accessories.

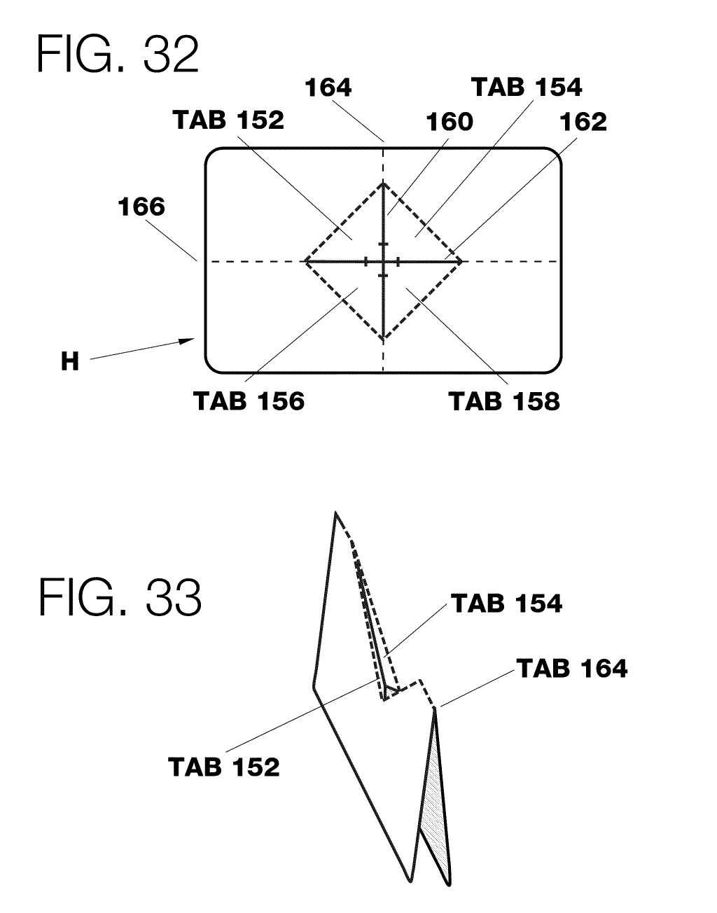

The eighth embodiment, Card H, (FIG. 32-FIG. 37) illustrates a “solid face” tee incorporating a four tab system. Further, Card H is a “bi-fold” card which can be folded vertically along JOINT 164 to create a narrow-front fold, or horizontally along JOINT 166 to create a wide-front fold, in order to accommodate different tee elevations. TAB 152, TAB 154, TAB 156, and TAB 158 are completely separated from each other and function independently. The golf ball can rest, under either the vertical or horizontal fold, upon the creases of TAB 152, TAB 154, TAB 156, and TAB 158.

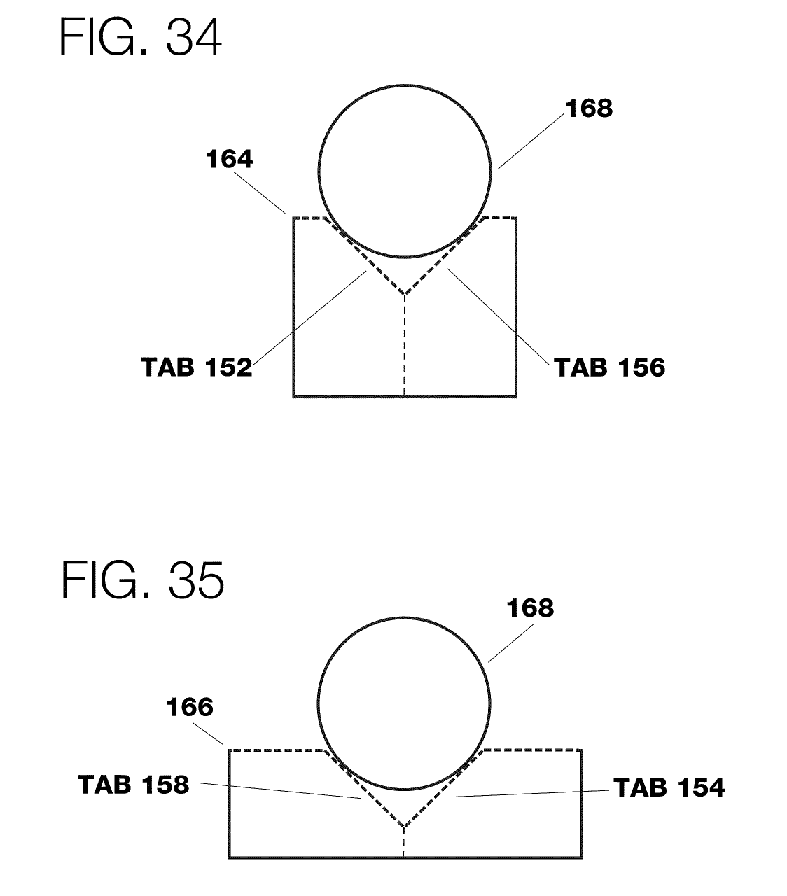

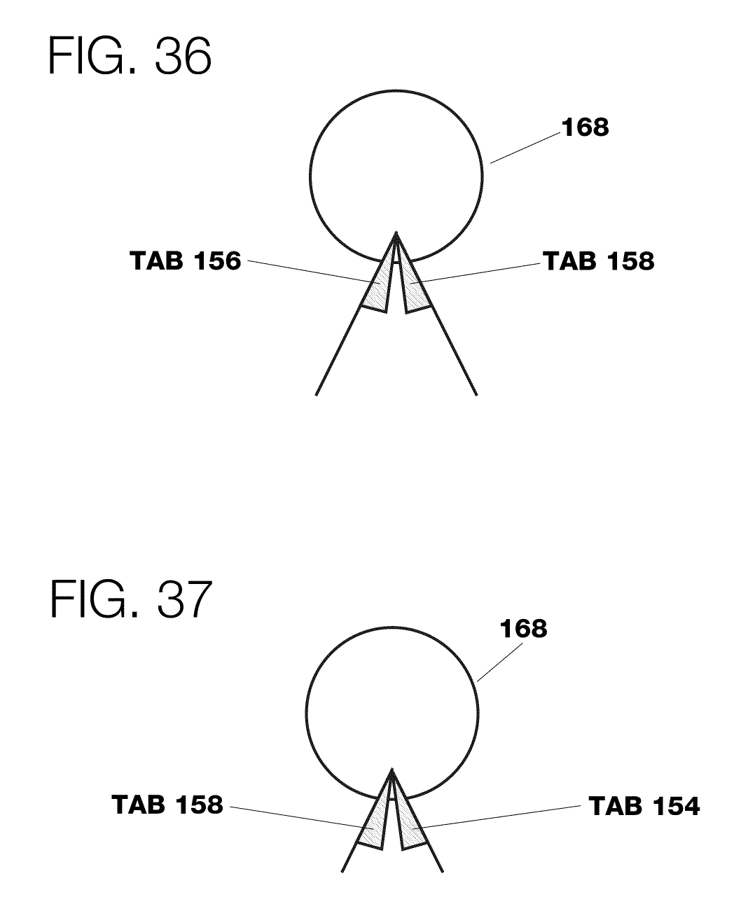

FIG. 33 is a functional, perspective view of the vertical fold application along joint 164 as it is used to function as a tee. As shown in FIG. 34 (functional, front view) and FIG. 36 (functional, side view), the golf ball 168 is placed upon the creases of TAB 152, TAB 154, TAB 156, and TAB 158. The elevation of the golf ball 168 can then be adjusted by widening or narrowing the angle of the folded card. After use of Card H as a golf tee, the card and TABS can then be returned to a flat position as shown in FIG. 32.

Similarly, FIG. 35 (functional, front view) and FIG. 37 (functional, side view) represent Card H with a horizontal fold application along JOINT 166. The golf ball 168 is placed upon the creases of TAB 152, TAB 154, TAB 156, and TAB 158. The elevation of the golf ball 168 can then be adjusted by widening or narrowing the angle of the folded card. After use of Card H as a golf tee, the card and tabs can then be returned to a flat position as shown in FIG. 32.

Alternatively, the TABS in Card H can be folded in the opposite direction as that shown in FIG. 33 such that the golf ball can rest upon the tabs themselves instead of the creases.

The ball markers in the subsequent embodiments are formable from the pocket-friendly golf accessory card of the present invention. They may be formed with a unique, retractable spike. This retractable spike serves the purpose of securing the marker in place, yet retracts for storage, convenience, and safety.

The ninth embodiment, Card J, (FIG. 38-FIG. 39) illustrates several ball markers. Ball markers 170 can be manually detached from Card J by the user. As shown in FIG. 39 (functional, perspective view), the user folds TAB 172 at JOINT 174 to a perpendicular position, then presses TAB 172 into the grass of the golf green. After use, the user can then return the marker to a flat and non-protruding position, and return the marker to Card J itself.

Alternatively, several shapes can be incorporated without diminishing the overall function of the marker system. For instance, a four leaf clover, an “iron cross”, a crucifix, and other popular or recognizable symbols and trademarks can be incorporated into the design of the marker or other accessories.

The tenth embodiment is a first multi-accessory card, Card K, (FIG. 40-FIG. 44) illustrates two low profile tees 176 and 178, and two types of ball markers 180 and 182. Card K further illustrates that multiple accessories of different types can be formed from a single card.

As shown in FIG. 41, tee 176 can be manually detached from Card K. The user can then fold out TAB 184, TAB 186, TAB 188, and TAB 190, and place a golf ball upon such tabs. After use, the tabs can then be returned to a flat position, and the tee 176 can be returned to Card K.

As shown in FIG. 42, tee 178 can be manually detached from Card K. The user can then fold out TAB 192, TAB 194, and TAB 196, and place a golf ball on such tabs. After use, the tabs can then be returned to a flat position, and the tee 178 can be returned to Card K.

Alternatively, tee 176 and tee 178 can also function as ball markers.

As shown in FIG. 43, ball marker 180 can be manually detached from Card K. The user can fold TAB 198 and TAB 200 to a perpendicular position, and then press the tabs into the grass of the golf green. After use, the tabs can be returned to a flat position, and the marker 180 can be returned to Card K.

As shown in FIG. 44, ball marker 182 can be manually detached from Card K. The user can fold TAB 202 to a perpendicular position, and then press the tab into the grass of the golf green. After use, the tabs can be returned to a flat position, and the marker 182 can be returned to Card K.

The eleventh embodiment, Card L, (FIG. 45-FIG. 47) illustrates a “pop-out” ball liner in which sections 204 and 205 are not tabs but either open sections or “pop-out” sections to be removed by the user. As shown in FIG. 46 (functional, perspective view), the user simply centers Card L around a golf ball 206 in order to mark a straight line on the golf ball with a writing implement. FIG. 47 shows golf ball 206 after the ball has been lined. Such lines are used by golfers to give a visual orientation to the direction of a putt. Any gaps created by the space between sections 204 and 205 can be filled in easily by the user.

The twelfth embodiment, Card M, (FIG. 48) illustrates a second multi-accessory card providing a combination of the above accessories. Ball marker 208 is essentially the same detachable marker from Card J. Ball liner 212 is an alternative embodiment of the ball liner from Card L. Tee 210 is essentially the same tee from Card D.

The thirteenth embodiment, Card N, (FIG. 49) illustrates a third multi-accessory card providing a combination of the above accessories. Ball marker 214 is essentially the same detachable marker 182 from Card K. Tee 216 is essentially the same tee from Card E. Card N includes an alternative embodiment of the card perimeter design by use of arched perimeters such as line 218. This embodiment creates sharper points at the base of the tee so that it can avoid irregularities in the golfing surface.

The fourteenth embodiment, Card P, (FIG. 50) illustrates a fourth multi-accessory card, comprising a combination of the above accessories. Tee 222 is essentially the same tee from Card G. Tee 224 is essentially the same low-profile and detachable tee 176 from Card K. Tee 220 is similar to tee 178 in Card K but for the fact that it is not detachable. Under this embodiment, tee 220 would function as a tee without removing it from Card P. Hole 226 is a “pop-out” and can be either an open section or a “pop-out” section to be removed by the user. This feature can be applied to any design so that user can attach the card to another object such as a golf bag, apparel, or otherwise.

The fifteenth embodiment, Card Q, (FIG. 51-FIG. 53) illustrates a second ball liner card. TAB 252 is the main function feature of the ball liner card and is outlined by lines 256, 258a, and 258b. CUTS 256 are complete through cuts in the material but for the TIES as represented by 260. The TIES are minute connectors which keep TAB 252 affixed to the card until manually separated by the user. JOINTS 258a and 258b are “hinges” in the material. Openings 254 are “knock outs” in the material wide enough to guide a marking pen.

Lines 262a, 262b, 264a, and 264b are alignment features that are optionally, but preferably, printed onto the card itself. Lines 262a and 262b aid the user in centering the golf ball on the card. Lines 264a/262b aid the user in creating a second set of lines perpendicular to the initial markings.

Hole 266 is an optional “knock out” so that the user can attach the card to other objects, such as apparel or a golf bag.

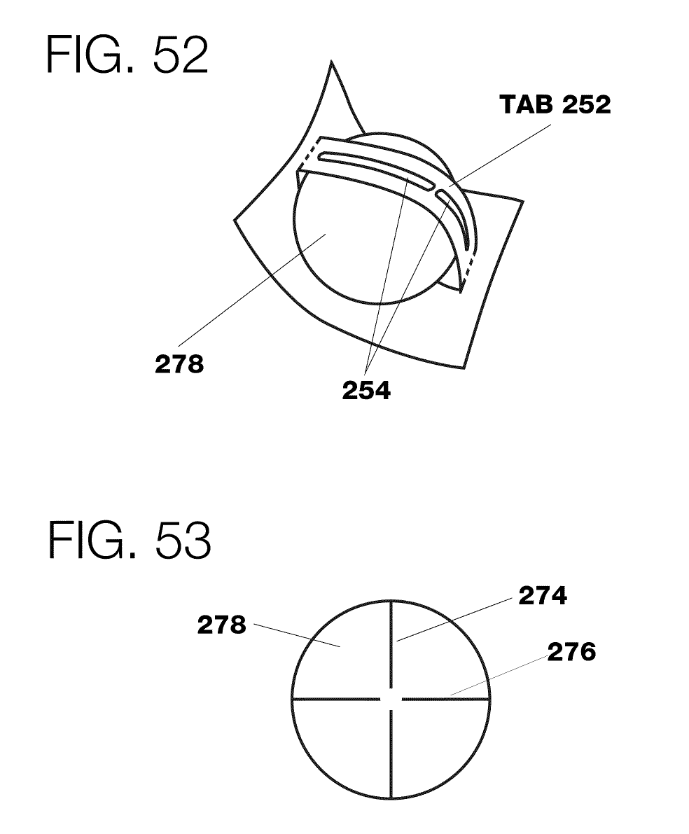

FIG. 52 illustrates the second ball liner card displaying its function. The user manually separates TAB 252 from the card itself, in opposite directions. The user then inserts a golf ball between TAB 252 and the card itself. This allows the user to center the golf ball underneath TAB 252 so that lines can be drawn on the golf ball using openings 254. Lines 262a and 262b (FIG. 51) aid in centering the golf ball.

Lines 264a and 264b are additional alignment feature which allows the user to reinsert the marked ball such that the initial markings on the ball are in line with lines 264a and 264b. Perpendicular lines can then be drawn on the golf ball (FIG. 53).

FIG. 53 is a top view of the lined ball. Line 274 represent the initial markings on the golf ball 278, and line 276 represents the optional perpendicular markings described above.

The sixteenth embodiment comprises a first directional vane card, Card R (FIG. 54-FIG. 58), showing two different versions of the directional vanes. Tee holes, such as hole 310, represent an opening in the material through which the base of a golf tee can be inserted, and the directional vane secured to the golf tee. The tee holes 310 can be a circular hole, a shaped hole (such as a star, heart, diamond, or the like that might complement a logo or other promotional feature) a cross cut section in the material, an asterisk-shaped perforation, a combination thereof, or other small openings configured to receive the shaft of a tee.

Vane 314 is a longer and detachable vane that points in a single direction. Vane 316 is an alternative version in which the detachable vane references opposing directions.

FIG. 55 is a top view of vane 316 as it is applied to a tee and a golf ball 318 placed thereon.

FIG. 56 is a top view of vane 314 as it is applied to a tee and a golf ball 318 placed thereon.

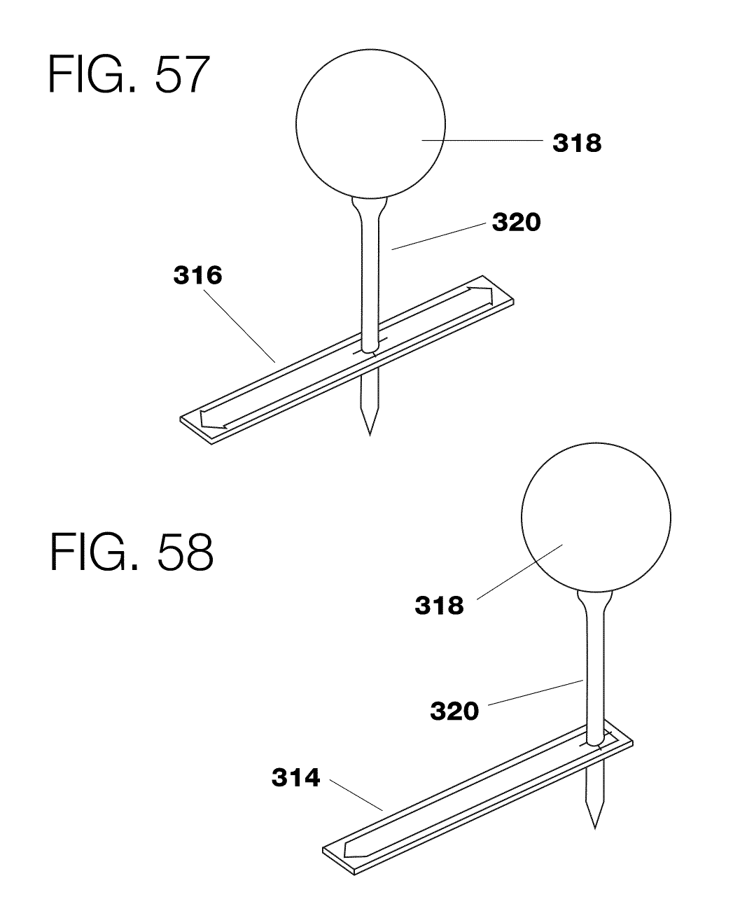

FIG. 57 is a perspective view of vane 316 as it is applied to a tee 320 and a golf ball 318 placed thereon.

FIG. 58 is a perspective view of vane 314 as it is applied to a tee 320 and a golf ball 318 placed thereon.

The seventeenth and eighteenth embodiments comprise additional directional vanes, Card S (FIG. 59-FIG. 61).

FIG. 59 is top view of a card, Card S, comprising two alternative versions of the directional vanes. Tee hole 328 is simply a cross cut section in the material as an example of a tee hole type. Tee hole 330 is simply a circular cut section in the material as an example of a tee hole type. Dashed line 22 allows the material to be separated to form two separate vanes.

Vanes 324 and 326 are alternatives to the above vanes of the sixteenth embodiment, Card R (FIG. 54-FIG. 58) in that the individual vanes are not separated entirely and individually from the card itself, remain substantially as an intact card, and reference four directions.

FIG. 60 is a top view of vane 324 or 326 as it is applied to a tee and a golf ball 318 placed thereon.

FIG. 61 is a perspective view of vane 324 or 326 as it is applied to a tee 320 and a golf ball 318 placed thereon.

The nineteenth embodiment comprises an additional directional vane, Card T (FIG. 62-FIG. 64).

FIG. 62 is top view of a card, Card T, comprising two alternative versions of the directional vanes, wherein vanes 336 and 338 can be separated entirely and individually from the card itself. Vane 336 is an example of a vane in which the directional indicators, or “arrows”, are printed or stamped into the material. Vane 338 is an example of a vane in which the directional indicators (arrows) are represented by the actual cut-out shape of the vane itself.

Ball marker 332 (FIG. 62) is an example of the several other golf accessories which can accompany the directional vanes. In this case, ball marker 332 can be detached from the card, and then applied to a golf green by bending tab 334 such that it acts as a “spike” in the grass. Thus, one or more other accessories can be combined in a single card with the directional vanes.

FIG. 63 is a top view of vane 336 as it is applied to a tee and a golf ball 318 placed thereon.

FIG. 64 is a perspective view of vane 336 as it is applied to a tee 320 and a golf ball 318 placed thereon.

The twentieth embodiment comprises an additional directional vane, Card U (FIG. 65). FIG. 65 is a top view of a combination card which essentially comprises all of the above versions of the directional vanes. Vanes 340 and 346 represent vanes 314 and 316 from FIG. 54. Vane 342 represents vane 336 from FIG. 62. Vane 344 represents vane 326 from FIG. 59. Tee holes 348, 350, and 352 are three different examples of how the vanes can be affixed to the tee.

Referring now to side view FIG. 66 and expanded view FIG. 67, the layers of the pocket-friendly golf accessory card produced by the preferred manufacturing technique are illustrated. The embodiment illustrated is the eighth embodiment of FIG. 32, but the principles disclosed are applicable to all embodiments of the invention.

First laminate layer 386 and second laminate layer 388 are preferably made of a clear laminate material. Layer 387 is a printable sheet substrate. The first laminate layer 386, printable sheet substrate layer 387, and second laminate layer 388 most preferably have a thickness of around 10 ml.

The first laminate layer 386 is configured with JOINTS 164, 166. Preferably the JOINTS 164, 166 are accomplished by scoring the first laminate layer (such as with a “kiss cut”) creating a failure point, such that the printable sheet substrate layer 387 and second laminate layer 388 act as a hinge or JOINT.

Most preferably the printable sheet substrate layer 87 comprises a Teslin® synthetic printing sheet substrate, which is pliable and tear resistant.

The manufacture steps generally include the following (the order of some of the manufacturing steps may vary): (1.) Printing either the top surface, the bottom surface, or both surfaces of the printable sheet substrate layer 387 with graphics, text, or other markings; (2.) Laminating both upper and lower surfaces of printable sheet substrate layer 387 with upper first laminate layer 386 and lower second laminate layer 388, generally with a clear laminate; (3.) Place sheet in press to cut through all or substantially all of laminated printable sheet substrate, forming interior and perimeter CUTS. Interior CUT 167 comprises CUT 167a through first laminate layer 386, CUT 167b through second laminate layer 388, and CUT 167c through second laminate layer 388. TIES (not show in FIG. 67) may be left to retain the golf accessory within the card until used; (4.) Simultaneously with the above step (3.), perform kiss cuts, which are shallow cuts of substantially only first laminate layer 386 to form JOINTS 164, 166.

In performing step (3.) and (4.), the joined layers are preferably put into a press having “steel-rule dies” of varying but precise depths. The JOINTS are formed by a blade piercing part, or all, of the top laminate layer 386, while other blades simultaneously cut the perimeter and interior CUTS.

The pocket-friendly golf accessory card 100 may be manufactured using conventional card cutting methods, such as, for example, stamping, die cutting, or laser cutting on a moving web or on individual unmoving sheets, or injection molding, or thermoforming. Preferably the golf accessory card 100 is stamped for economy of production. Further, the edges may be beveled, creating a smooth feel and minimizing scratches that could occur from raw edges.

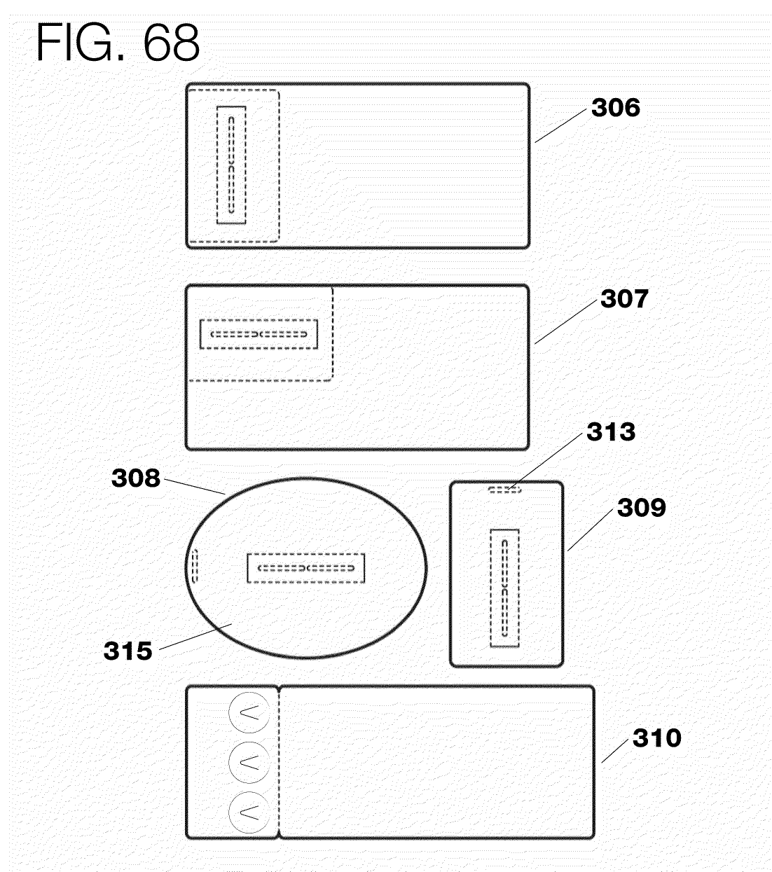

FIG. 68 is a diagram of exemplary template layouts and applications for the pocket-friendly golf accessory card. As illustrated, many and varied layouts can be used, due to the ease of manufacturing. Various shapes can be utilized for convenience or for personalization; for example, an oval shape 308, rectangular shape 309, other geometric shapes, or logo-driven shapes.

The pocket-friendly golf accessory card can be imprinted, embossed, or otherwise marked with any of a variety of logos, text, and/or graphics 315 or other markings. Such markings may be desirable for any of a variety of commercial or private distributions. Such markings comprise detailed graphics, instructional diagrams, promotional or marketing symbols, redeemable coupons, text, barcodes, magnetic stripes, photos, or the like. The pocket-friendly golf accessory card can be used as a tradeshow give-away, as a business card, as a personalized gift, as a luggage tag, within a mailing for advertisement purposes, within a birthday card, as a memento of an occasion, as a golf bag tag, as an apparel tag, as a rack display or brochure, or the like. Other holes 313 (FIG. 68) unrelated to the functioning of the golf accessory may optionally be included, such as, for example, when the pocket-friendly golf accessory card is prepared to attach to a golf bag, to a purse, or to a key chain or when non-functional holes 313 may be advantageously incorporated into a desired, customized design.

While twenty embodiments are herein presented, the presentation is merely exemplary and not limiting. Other variations are within the scope of the invention, such as the following: variations in the joint-able material; variations in the manufacturing techniques; variations in the printing, embossing, or other markings of the face and/or of the reverse; variations in the perimeter shape of the accessory card; variations in proportions; elimination of the non-essential parts of the overall card to produce only the accessory; and variations in the number, type, combination, and placement of the accessories.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

I claim:

1. A card from which a golf accessory can be formed, comprising a thin, flat sheet of joint-able material, wherein said sheet is configured with at least one CUT within the interior of said sheet, said CUT formed by cutting at least substantially through said sheet, and wherein said sheet is configured with at least one manually bendable JOINT formed by cutting through a portion of said sheet, whereby by manual manipulation of said at least one CUT and said at least one JOINT said golf accessory is formable.

2. The card, as recited in claim 1, wherein said golf accessory comprises a golf tee.

3. The card, as recited in claim 2, wherein said golf tee is configured with at least two contact points configured to support a golf ball.

4. The card, as recited in claim 1, wherein said golf accessory comprises a golf directional vane configured with at least one hole for receiving a shaft of a tee.

5. The card, as recited in claim 1, wherein said golf accessory comprises a ball liner configured with at least one stencil.

6. The card, as recited in claim 1, wherein said golf accessory comprises a ball marker.

7. The card, as recited in claim 6, wherein said ball marker comprises a spike formable by manipulating said at least one manually bendable JOINT.

8. The card, as recited in claim 1, wherein:
said at least one manually bendable JOINT comprises multiple JOINTS and said at least one CUT comprises multiple CUTS;
multiple golf accessories are formable by manual manipulation of said multiple JOINTS and of said at multiple CUTS; and
said multiple golf accessories comprise more than one golf accessory from the following: a ball marker, a ball liner, a golf directional vane, and a golf tee.

9. The card, as recited in claim 1, wherein said joint-able material comprises a PVC plastic.

10. The card, as recited in claim 1, wherein said joint-able material comprises a laminated printable sheet substrate.

11. The card, as recited in claim 8, wherein said laminated printable sheet substrate comprises laminated Teslin®.

12. The card, as recited in claim 1, further comprising a TAB at least partially separated from the remainder of said thin, flat sheet of joint-able material and configured to generally function outside the plane of said thin, flat sheet of joint-able material.

13. A golf accessory card, comprising a thin, flat sheet of semi-rigid laminated printable sheet substrate, wherein said sheet is configured with one or more CUTS within the interior of said sheet formed by cutting at least substantially through said sheet, and wherein said sheet is configured with one or more manually bendable JOINTS formed by cutting through a portion of said sheet, wherein upon manual manipulation of said one or more CUTS and of said one or more manually bendable JOINTS one or more golf accessories are formable, and wherein said one or more golf accessories comprise one or more from the following group: a golf tee, a golf directional vane configured with at least one hole for receiving a shaft of a golf tee, a ball liner, and a ball marker.

14. A method of manufacturing a golf accessory card, comprising:
printing markings on at least one surface of a printable sheet substrate having an upper surface and a lower surface;
laminating said upper surface and said lower surface of said printable sheet substrate with upper first laminate layer and lower second laminate layer, respectively; and
cutting said upper first laminate layer to form a JOINT, wherein said JOINT is configured to allow manual formation of a golf accessory from said golf accessory card.

15. The method, as recited in claim 14, wherein said printable sheet substrate comprises Teslin®.

16. The method, as recited in claim 14, further comprising:
cutting through at least one interior area of the joined said upper first laminate layer, said printable sheet substrate layer, and said lower second laminate layer resulting in a CUT; wherein said CUT is configured to allow manual formation of a golf accessory from said golf accessory card.

17. The method, as recited in claim 14, further comprising:
pressing out the external perimeter of the joined said upper first laminate layer, said printable sheet substrate, and said lower second laminate layer.

18. The method, as recited in claim 14, wherein said markings comprise graphics.

19. The method, as recited in claim 14, wherein said markings comprise text.
